(19) United States
(12) Patent Application Publication
(10) Pub. No.: US 2025/0234322 A1
(43) Pub. Date: Jul. 17, 2025

(54) POSITIONING MODEL REGISTRATION

(71) Applicant: QUALCOMM Incorporated, San Diego, CA (US)

(72) Inventors: Mohammed Ali Mohammed HIRZALLAH, San Marcos, CA (US); Taesang YOO, San Diego, CA (US); Rajat PRAKASH, San Diego, CA (US)

(21) Appl. No.: 18/410,906

(22) Filed: Jan. 11, 2024

(51) Int. Cl. H04W 64/00; G01S 5/00; G01S 5/02

(52) U.S. Cl. CPC H04W 64/00; G01S 5/0027; G01S 5/0236

(57) ABSTRACT

A user equipment (UE) may receive a positioning model registration message. The positioning model registration message may include a set of positioning model IDs and an indicator of a set of positioning model configurations. Each of the set of positioning model IDs may be associated with at least one of the set of positioning model configurations. The UE may receive a set of positioning signals. The UE may measure the set of positioning signals. The UE may select a positioning model ID from the set of positioning model IDs based on the set of positioning model configurations and an environmental attribute of the UE. The UE may calculate a set of positioning model outputs based on the measured set of positioning signals and a positioning model associated with the selected positioning model ID.

### TECHNICAL FIELD

The present disclosure relates generally to communication systems, and more particularly, to a wireless positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new conditions associated with latency, reliability, security, scalability (e.g., with Internet of Things (IoT)), and other conditions. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may receive a positioning model registration message. The positioning model registration message may include a set of positioning model identifiers (IDs) and an indicator of a set of positioning model configurations. Each of the set of positioning model IDs may be associated with at least one of the set of positioning model configurations. The apparatus may receive a set of positioning signals. The apparatus may measure the set of positioning signals. The apparatus may select a positioning model ID from the set of positioning model IDs based on the set of positioning model configurations and an environmental attribute of the apparatus. The apparatus may calculate a set of positioning model outputs based on the measured set of positioning signals and a positioning model associated with the selected positioning model ID.

In an aspect of the disclosure, a method, a computer-readable medium, and an apparatus are provided. The apparatus may include a network node. The network node may include a location management function (LMF). The apparatus may register a set of positioning model IDs and a set of positioning model configurations with a positioning model ID database such that each of the set of positioning model IDs is associated with at least one of the set of positioning model configurations in the positioning model ID database. The apparatus may transmit a positioning model registration message. The positioning model registration message may include the registered set of positioning model IDs and an indicator of the registered set of positioning model configurations.

In an aspect of the disclosure, a method, a computer-readable medium, and an apparatus are provided. The apparatus may include a UE. The apparatus may receive a positioning configuration. The positioning configuration may include an indicator for the apparatus to use a plurality of positioning models. The apparatus may receive a set of positioning signals. The apparatus may measure the set of positioning signals. The apparatus may calculate a first set of positioning model outputs based on a first positioning model of the plurality of positioning models and the measured set of positioning signals and a second set of positioning model outputs based on a second positioning model of the plurality of positioning models and the measured set of positioning signals.

In an aspect of the disclosure, a method, a computer-readable medium, and an apparatus are provided. The apparatus may include a network node. The network node may include an LMF. The apparatus may calculate a positioning configuration. The positioning configuration may include an indicator for a UE to use a plurality of positioning models on a set of positioning signals. The apparatus may transmit the positioning configuration. The positioning configuration may include an indicator for the set of positioning signals to be transmitted by a set of wireless devices (e.g., a set of transmission reception points (TRPs)) and/or received by the UE.

In some aspects, the techniques described herein relate to a method of wireless communication at a user equipment (UE), including: receiving a positioning model registration message including a set of positioning model IDs and an indicator of a set of positioning model configurations, where each of the set of positioning model IDs is associated with at least one of the set of positioning model configurations; receiving a set of positioning signals; measuring the set of positioning signals; selecting a positioning model ID from the set of positioning model IDs based on the set of positioning model configurations and an environmental attribute of the UE; and calculating a set of positioning model outputs based on the measured set of positioning signals and a positioning model associated with the selected positioning model ID.

In some aspects, the techniques described herein relate to a method, further including: transmitting a request message including a request for the positioning model registration message before the reception of the positioning model registration message.

In some aspects, the techniques described herein relate to a method, where the request message further may include a set of potential IDs, where a first subset of the set of positioning model IDs may include a second subset of the set of potential IDs.

In some aspects, the techniques described herein relate to a method, where the request message further may include a set of potential positioning model configurations, where a first subset of the set of positioning model configurations may include a second subset of the set of potential positioning model configurations, where each of the set of potential positioning model configurations may include at least one of: a suggested area for a suggested positioning model; a suggested time period for the suggested positioning model; a suggested duration for the suggested positioning model; or a suggested globality database for the suggested positioning model.

In some aspects, the techniques described herein relate to a method, where the request message further may include a second indicator of a number of requested model IDs, where the set of positioning model IDs may include the number of requested model IDs.

In some aspects, the techniques described herein relate to a method, where the positioning model registration message may include a second indicator of a globality database associated with the set of positioning model IDs and the set of positioning model configurations, where the globality database is associated with at least one of: a first positioning model ID database including a first set of unique model IDs for an entire planet; a second positioning model ID database including a second set of unique model IDs for a network; a third positioning model ID database including a third set of unique model IDs for an area; or a fourth positioning model ID database including a fourth set of unique model IDs for a UE vendor.

In some aspects, the techniques described herein relate to a method, further including: transmitting a positioning model registration failure message including a second indicator of at least one of the set of positioning model IDs that is invalid for registration with the UE; and receiving a second positioning model registration message including a second set of positioning model IDs and a third indicator of the set of positioning model configurations, where each of the second set of positioning model IDs is associated with at least one of the set of positioning model configurations, where the second set of positioning model IDs does not include at least one of the set of positioning model IDs that is invalid for registration with the UE, where the second set of positioning model IDs may include the selected positioning model ID.

In some aspects, the techniques described herein relate to a method, further including: transmitting a request message including a request for the second positioning model registration message before the reception of the second positioning model registration message.

In some aspects, the techniques described herein relate to a method, further including: transmitting a report message including a second indicator of the selected positioning model ID and a third indicator of at least one of the calculated set of positioning model outputs.

In some aspects, the techniques described herein relate to a method, further including: receiving a positioning model registration failure message including a fourth indicator that the selected positioning model ID is invalid for registration; and receiving a second positioning model registration message including a second set of positioning model IDs, where each of the second set of positioning model IDs is associated with at least one of a second set of positioning model configurations, where the second set of positioning model IDs does not include the selected positioning model ID.

In some aspects, the techniques described herein relate to a method, further including: transmitting a request message including a request for the second positioning model registration message before the reception of the second positioning model registration message.

In some aspects, the techniques described herein relate to a method, where the environmental attribute of the UE may include at least one of: an area associated with a calculated location of the UE; a region associated with the calculated location of the UE; a time period associated with a clock of the UE; or a duration associated with the clock of the UE.

In some aspects, the techniques described herein relate to a method, including: receiving a positioning configuration including a second indicator of a plurality of positioning model IDs associated with a plurality of positioning models, where the plurality of positioning model IDs may include the selected positioning model ID and a second positioning model ID, where selecting the positioning model ID may include selecting the plurality of positioning model IDs from the set of positioning model IDs based on the positioning configuration; and calculating a second set of positioning model outputs based on the measured set of positioning signals and a second positioning model associated with the second positioning model ID.

In some aspects, the techniques described herein relate to a method, further including: transmitting a positioning report including a third indicator of the set of positioning model outputs and a fourth indicator of the second set of positioning model outputs.

In some aspects, the techniques described herein relate to a method, where the positioning configuration may include a report configuration for the positioning report, where the report configuration may include at least one of: a timing for the transmission of the positioning report; an event trigger associated with the transmission of the positioning report; or a priority indicator for each of a plurality of positioning model outputs, where the plurality of positioning model outputs may include the set of positioning model outputs and the second set of positioning model outputs.

In some aspects, the techniques described herein relate to a method, further including: transmitting a first positioning report including a third indicator of at least one of the set of positioning model outputs; and transmitting a second positioning report including a fourth indicator of at least one of the second set of positioning model outputs.

In some aspects, the techniques described herein relate to a method, further including: obtaining a set of measurement inputs; obtaining a set of labels; and training the plurality of positioning models based on the set of measurement inputs and the set of labels using artificial intelligence machine learning (AI/ML).

In some aspects, the techniques described herein relate to a method, where at least one of the set of positioning model outputs may include a first output type and at least one of the second set of positioning model outputs may include a second output type, where the first output type and the second output type are different.

In some aspects, the techniques described herein relate to a method, where a plurality of output types include the first output type and the second output type, where the plurality of output types include at least two of: a reference signal time difference (RSTD); a line of sight (LOS) indicator; a multipath timing indicator; a multipath power indicator; a multipath phase indicator; a reference signal received power (RSRP); or an angle of departure (AoD).

In some aspects, the techniques described herein relate to a method, where the positioning configuration may include a third indicator of the first output type and a fourth indicator of the second output type.

In some aspects, the techniques described herein relate to a method, where the positioning configuration may include a third indicator of a first set of resources associated with the positioning model and the measured set of positioning signals and a fourth indicator of a second set of resources associated with the second positioning model and the measured set of positioning signals, where calculating the set of positioning model outputs and the second set of positioning model outputs includes calculating the set of positioning model outputs further based on the first set of resources and the second set of positioning model outputs further based on the second set of resources.

In some aspects, the techniques described herein relate to a method, where the first set of resources may include at least one of: a type of the set of positioning signals; a bandwidth (BW) of the set of positioning signals; a timing of the set of positioning signals; or an event trigger associated with the calculation of the set of positioning model outputs.

In some aspects, the techniques described herein relate to a method, where the positioning configuration may include a third indicator of a set of resources associated with the positioning model, the second positioning model, and the measured set of positioning signals, where calculating the set of positioning model outputs and the second set of positioning model outputs includes calculating the set of positioning model outputs and the second set of positioning model outputs further based on the set of resources.

In some aspects, the techniques described herein relate to a method, where the set of resources may include at least one of: a type of the set of positioning signals; a bandwidth (BW) of the set of positioning signals; a timing of the set of positioning signals; or an event trigger associated with the calculation of the set of positioning signals.

In some aspects, the techniques described herein relate to a method, where the positioning configuration may include a third indicator of the positioning model and a fourth indicator of the second positioning model, further including: transmitting a first request for the positioning model based on the third indicator; transmitting a second request for the second positioning model based on the fourth indicator; receiving the positioning model after the transmission of the first request; and receiving the second positioning model after the transmission of the second request.

In some aspects, the techniques described herein relate to a method, where receiving the positioning configuration includes receiving a long term evolution (LTE) positioning protocol (LPP) message including the positioning configuration.

In some aspects, the techniques described herein relate to a method, where the LPP message may include at least one of: a location provide message; an assistance data message; a broadcast LPP message; or a positioning system information block (posSIB) LPP message.

In some aspects, the techniques described herein relate to a method, further including: transmitting a request for the positioning configuration before the reception of the positioning configuration.

In some aspects, the techniques described herein relate to a method, further including: receiving a third indicator that a network entity has a capability of transmitting the positioning configuration including the second indicator for the UE to use the plurality of positioning models, where the transmission is in response to the third indicator.

In some aspects, the techniques described herein relate to a method, further including: transmitting a capability message including a third indicator that the UE is configured to concurrently calculate a plurality of positioning model outputs based on the plurality of positioning models before the reception of the positioning configuration.

In some aspects, the techniques described herein relate to a method, where the capability message may include a fourth indicator of a plurality of output types, where the plurality of output types may include a first output type of at least one of the set of positioning model outputs and a second output type of at least one of the second set of positioning model outputs, where the positioning configuration may include a fifth indicator for the UE to report the at least one of the set of positioning model outputs of the first output type and the at least one of the second set of positioning model outputs of the second output type.

In some aspects, the techniques described herein relate to a method, where the plurality of output types include at least two of: a reference signal time difference (RSTD); a line of sight (LOS) indicator; a multipath timing indicator; a multipath power indicator; a multipath phase indicator; a reference signal received power (RSRP); or an angle of departure (AoD).

In some aspects, the techniques described herein relate to a method, where the capability message may include a fourth indicator of a resource constraint associated with the reception of the set of positioning signals, where the resource constraint may include at least one of a maximum bandwidth or a maximum number of measurement occasions, where the positioning configuration may include a fifth indicator of a resource of the set of positioning signals that conforms to the resource constraint. In some aspects, the techniques described herein relate to a method, where the capability message may include a fourth indicator of a first set of measurement gaps, where the positioning configuration may include a fifth indicator of a second set of measurement gaps associated with at least one of the measurement of the set of positioning signals, the calculation of the set of positioning model outputs and the second set of positioning model outputs, or a transmission of a positioning report including a sixth indicator of at least one of the set of positioning model outputs and a seventh indicator of at least one of the second set of positioning model outputs, where at least one of the second set of measurement gaps is greater than or equal to at least one of the first set of measurement gaps.

In some aspects, the techniques described herein relate to a method, further including: receiving a second request for the capability message, where the transmission of the capability message is in response to the reception of the second request.

In some aspects, the techniques described herein relate to a method, where transmitting the capability message includes transmitting a long term evolution (LTE) positioning protocol (LPP) message including the capability message.

In some aspects, the techniques described herein relate to a method, where the LPP message may include a capability exchange message.

In some aspects, the techniques described herein relate to a method of wireless communication at a network entity, including: registering a set of positioning model IDs and a set of positioning model configurations with a positioning model ID database such that each of the set of positioning model IDs is associated with at least one of the set of positioning model configurations in the positioning model ID database; and transmitting a positioning model registration message including the registered set of positioning model IDs and an indicator of the registered set of positioning model configurations.

In some aspects, the techniques described herein relate to a method, further including: receiving a request message including a request for the positioning model registration message, where the transmission of the positioning model registration message is in response to the request.

In some aspects, the techniques described herein relate to a method, where the request message further may include a set of potential IDs. The method may further include selecting a first subset of the set of potential IDs from the set of potential IDs for the set of positioning model IDs before the registration of the set of positioning model IDs.

In some aspects, the techniques described herein relate to a method, where the request message may include a set of potential positioning model configurations, further including configuring the set of positioning model configurations based on the set of potential positioning model configurations, where each of the set of potential positioning model configurations may include at least one of: a suggested area for a positioning model; a suggested region for the positioning model; a suggested time period for the positioning model; a suggested duration for the positioning model; or a suggested globality for the positioning model ID database.

In some aspects, the techniques described herein relate to a method, where the request message may include a second indicator of a first number of requested model IDs, further including: configuring a second number of the set of positioning model IDs based on the first number of requested model IDs, where the second number is less than or equal to the first number.

In some aspects, the techniques described herein relate to a method, where the positioning model ID database may include a globality database associated with at least one of: a first set of unique model IDs for an entire planet; a second set of unique model IDs for a network; a third set of unique model IDs for an area; or a fourth set of unique model IDs for a UE vendor.

In some aspects, the techniques described herein relate to a method, where the positioning model registration message may include a second indicator of a globality of the positioning model ID database.

In some aspects, the techniques described herein relate to a method, further including: receiving a positioning model registration failure message including a second indicator of at least one of the set of positioning model IDs that is invalid for registration with a user equipment (UE); registering a second set of positioning model IDs and the set of positioning model configurations with the positioning model ID database such that each of the second set of positioning model IDs is associated with at least one of the set of positioning model configurations in the positioning model ID database, where the second set of positioning model IDs does not include at least one of the set of positioning model IDs that is invalid for registration with the UE; and transmitting a second positioning model registration message including the second set of positioning model IDs and a third indicator of the set of positioning model configurations.

In some aspects, the techniques described herein relate to a method, further including: receiving a request message including a request for the second positioning model registration message, where the transmission of the second positioning model registration message is in response to the request.

In some aspects, the techniques described herein relate to a method, further including: receiving a report message including a second indicator of a selected positioning model ID and a third indicator of a calculated set of positioning model outputs, where the set of positioning model IDs may include the selected positioning model ID.

In some aspects, the techniques described herein relate to a method, further including: transmitting a positioning model registration failure message including a fourth indicator that the selected positioning model ID is invalid for registration; and transmitting a second positioning model registration message including a second set of positioning model IDs and a second fifth of the set of positioning model configurations, where each of the second set of positioning model IDs is associated with at least one of the set of positioning model configurations, where the second set of positioning model IDs does not include the selected positioning model ID.

In some aspects, the techniques described herein relate to a method, further including: receiving a request message including a request for the second positioning model registration message, where the transmission of the second positioning model registration message is in response to the request.

In some aspects, the techniques described herein relate to a method, including: transmitting a positioning configuration including a second indicator of a plurality of positioning model IDs, where the set of positioning model IDs include the plurality of positioning model IDs; and receiving a positioning report including a third indicator of a set of positioning model outputs based on the positioning configuration.

In some aspects, the techniques described herein relate to a method, where the network entity may include a location management function (LMF).

In some aspects, the techniques described herein relate to a method of wireless communication at a user equipment (UE) including: receiving a positioning configuration including an indicator for the UE to use a plurality of positioning models; receiving a set of positioning signals; measuring the set of positioning signals; and calculating a first set of positioning model outputs based on a first positioning model of the plurality of positioning models and the measured set of positioning signals and a second set of positioning model outputs based on a second positioning model of the plurality of positioning models and the measured set of positioning signals.

In some aspects, the techniques described herein relate to a method, further including: transmitting a positioning report including a second indicator of at least one of the first set of positioning model outputs and a third indicator of at least one of the second set of positioning model outputs.

In some aspects, the techniques described herein relate to a method, where the positioning configuration may include a report configuration for the positioning report, where the report configuration may include at least one of: a timing for the transmission of the positioning report; an event trigger associated with the transmission of the positioning report; or a priority indicator for each of a plurality of positioning model outputs, where the plurality of positioning model outputs may include the first set of positioning model outputs and the second set of positioning model outputs.

In some aspects, the techniques described herein relate to a method, further including: transmitting a first positioning report including a second indicator of at least one of the first set of positioning model outputs; and transmitting a second positioning report including a third indicator of at least one of the second set of positioning model outputs.

In some aspects, the techniques described herein relate to a method, further including: obtaining a set of measurement inputs; obtaining a set of labels; and training the plurality of positioning models based on the set of measurement inputs and the set of labels using artificial intelligence machine learning (AI/ML).

In some aspects, the techniques described herein relate to a method, where at least one of the first set of positioning model outputs may include a first output type and at least one of the second set of positioning model outputs may include a second output type, where the first output type and the second output type are different.

In some aspects, the techniques described herein relate to a method, where a plurality of output types include the first output type and the second output type, where the plurality of output types include at least two of: a reference signal time difference (RSTD); a line of sight (LOS) indicator; a multipath timing indicator; a multipath power indicator; a multipath phase indicator; a reference signal received power (RSRP); or an angle of departure (AoD).

In some aspects, the techniques described herein relate to a method, where the positioning configuration may include a second indicator of the first output type and a third indicator of the second output type.

In some aspects, the techniques described herein relate to a method, where the positioning configuration may include a second indicator of a first set of resources associated with the first positioning model and the measured set of positioning signals and a third indicator of a second set of resources associated with the second positioning model and the measured set of positioning signals, where calculating the first set of positioning model outputs and the second set of positioning model outputs includes calculating the first set of positioning model outputs further based on the first set of resources and the second set of positioning model outputs further based on the second set of resources.

In some aspects, the techniques described herein relate to a method, where the first set of resources may include at least one of: a type of the set of positioning signals; a bandwidth (BW) of the set of positioning signals; a timing of the set of positioning signals; or an event trigger associated with the calculation of the first set of positioning model outputs and the second set of positioning model outputs.

In some aspects, the techniques described herein relate to a method, where the positioning configuration may include a second indicator of a set of resources associated with the first positioning model, the second positioning model, and the measured set of positioning signals, where calculating the first set of positioning model outputs and the second set of positioning model outputs includes calculating the first set of positioning model outputs and the second set of positioning model outputs further based on the set of resources.

In some aspects, the techniques described herein relate to a method, where the set of resources may include at least one of: a type of the set of positioning signals; a bandwidth (BW) of the set of positioning signals; a timing of the set of positioning signals; or an event trigger associated with the calculation of the set of positioning signals.

In some aspects, the techniques described herein relate to a method, where the positioning configuration may include a second indicator of the first positioning model and a third indicator of the second positioning model, further including: transmitting a first request for the first positioning model based on the second indicator; transmitting a second request for the second positioning model based on the third indicator; receiving the first positioning model after the transmission of the first request; and receiving the second positioning model after the transmission of the second request.

In some aspects, the techniques described herein relate to a method, where receiving the positioning configuration includes receiving a long term evolution (LTE) positioning protocol (LPP) message including the positioning configuration.

In some aspects, the techniques described herein relate to a method, where the LPP message may include at least one of: a location provide message; an assistance data message; a broadcast LPP message; or a positioning system information block (posSIB) LPP message.

In some aspects, the techniques described herein relate to a method, further including: transmitting a request for the positioning configuration before the reception of the positioning configuration.

In some aspects, the techniques described herein relate to a method, further including: receiving a second indicator that a network entity has a capability of transmitting the positioning configuration including the indicator for the UE to use the plurality of positioning models, where the transmission is in response to the second indicator.

In some aspects, the techniques described herein relate to a method, further including: transmitting a capability message including a second indicator that the UE is configured to concurrently calculate a plurality of positioning model outputs based on the plurality of positioning models before the reception of the positioning configuration.

In some aspects, the techniques described herein relate to a method, where the capability message may include a third indicator of a plurality of output types, where the plurality of output types may include a first output type of at least one of the first set of positioning model outputs and a second output type of at least one of the second set of positioning model outputs, where the positioning configuration may include a fifth indicator for the UE to report the at least one of the first set of positioning model outputs of the first output type and the at least one of the second set of positioning model outputs of the second output type.

In some aspects, the techniques described herein relate to a method, where the plurality of output types include at least two of: a reference signal time difference (RSTD); a line of sight (LOS) indicator; a multipath timing indicator; a multipath power indicator; a multipath phase indicator; a reference signal received power (RSRP); or an angle of departure (AoD).

In some aspects, the techniques described herein relate to a method, where the capability message may include a third indicator of a resource constraint associated with the reception of the set of positioning signals, where the resource constraint may include at least one of a maximum bandwidth or a maximum number of measurement occasions, where the positioning configuration may include a fourth indicator of a resource of the set of positioning signals that conforms to the resource constraint.

In some aspects, the techniques described herein relate to a method, where the capability message may include a third indicator of a first set of measurement gaps, where the positioning configuration may include a fourth indicator of a second set of measurement gaps associated with at least one of the measurement of the set of positioning signals, the calculation of the first set of positioning model outputs and the second set of positioning model outputs, or a transmission of a positioning report including a fifth indicator of at least one of the first set of positioning model outputs and a sixth indicator of at least one of the second set of positioning model outputs, where at least one of the second set of measurement gaps is greater than or equal to at least one of the first set of measurement gaps.

In some aspects, the techniques described herein relate to a method, further including receiving a second request for the capability message, where the transmission of the capability message is in response to the reception of the second request.

In some aspects, the techniques described herein relate to a method, where transmitting the capability message includes transmitting a long term evolution (LTE) positioning protocol (LPP) message including the capability message.

In some aspects, the techniques described herein relate to a method, where the LPP message may include a capability exchange message.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a positioning based on positioning signal measurements.

FIG. 5 is a diagram illustrating an example of positioning based on positioning signal measurements.

FIG. 6A is a diagram illustrating an example of positioning models configured to process a set of inputs to calculate a set of outputs.

FIG. 6B is a diagram illustrating an example of positioning models configured to process a set of inputs to calculate a plurality of sets of outputs.

FIG. 7 is a connection flow diagram illustrating an example of a network entity configured to register a set of positioning model IDs based on a request from a positioning target wireless device.

FIG. 8 is a connection flow diagram illustrating an example of a positioning target wireless device configured to indicate to a network entity of a positioning model ID registration failure.

FIG. 9 is a connection flow diagram illustrating an example of a network entity configured to indicate to a positioning target wireless device of a positioning model ID registration failure.

FIG. 10 is a connection flow diagram illustrating an example of a positioning target wireless device configured to calculate a plurality of outputs based on a plurality of positioning models.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to positioning utilizing wireless devices. Some aspects more specifically relate to wireless devices configured to register positioning model IDs for efficient designation of positioning models. Some aspects more specifically relate to wireless devices configured to calculate a plurality of outputs using a plurality of positioning models.

In some examples, a user equipment (UE) may receive a positioning model registration message. The positioning model registration message may include a set of positioning model IDs and an indicator of a set of positioning model configurations. Each of the set of positioning model IDs may be associated with at least one of the set of positioning model configurations. The UE may receive a set of positioning signals. The UE may measure the set of positioning signals. The UE may select a positioning model ID from the set of positioning model IDs based on the set of positioning model configurations and an environmental attribute of the UE. The UE may calculate a set of positioning model outputs based on the measured set of positioning signals and a positioning model associated with the selected positioning model ID. In some examples, a network node, for example a location management function (LMF), may register a set of positioning model IDs and a set of positioning model configurations with a positioning model ID database such that each of the set of positioning model IDs is associated with at least one of the set of positioning model configurations in the positioning model ID database. The network node may transmit a positioning model registration message. The positioning model registration message may include the registered set of positioning model IDs and an indicator of the registered set of positioning model configurations.

In some examples, a UE may receive a positioning configuration. The positioning configuration may include an indicator for the UE to use a plurality of positioning models. The UE may receive a set of positioning signals. The UE may measure the set of positioning signals. The UE may calculate a first set of positioning model outputs based on a first positioning model of the plurality of positioning models and the measured set of positioning signals and a second set of positioning model outputs based on a second positioning model of the plurality of positioning models and the measured set of positioning signals. In some examples, a network node, such as an LMF, may calculate a positioning configuration. The positioning configuration may include an indicator for a UE to use a plurality of positioning models on a set of positioning signals. The network node may transmit the positioning configuration. The positioning configuration may include an indicator for the set of positioning signals to be transmitted by a set of wireless devices (e.g., a set of transmission reception points (TRPs)) and/or for the set of positioning signals to be received by the UE for processing by the plurality of positioning models.

In some aspects, a set of wireless devices may be configured to register and assign appropriate IDs for positioning models, such as positioning models at a UE or a positioning models at a network node. Such registration of positioning model IDs may allow for easier signaling of life cycle management (LCM) operations between a network node (e.g., an LMF) and a UE. A positioning model may include a positioning model generated using artificial intelligence machine learning (AI/ML), a positioning model generated by an algorithm that processes inputs to generate outputs, or a positioning model provided as a logical or physical black box that processes inputs to generate outputs. In other words, a positioning model may be logical, physical, or functional. A positioning model may be specific to certain radio characteristics (e.g., delay spread, Doppler, spatial relation, a combination of spatial relations) and/or to certain site implementations. In one aspect, a UE may request a set of positioning model IDs from a network node for the UE to use to register a set of positioning models. In another aspect, a UE may suggest a set of positioning model IDs for the network node to use to register a set of positioning models. In another aspect, a network node may suggest a set of positioning model IDs for the UE to use to register a set of positioning models.

In some aspects, a set of wireless devices may be configured to designate a UE to use a plurality of positioning models to calculate a plurality of outputs based on a set of positioning signals transmitted to the UE. In some aspects, the UE may indicate a capability for joint positioning approaches (e.g., joint time difference of arrival (TDoA) and angle of departure (AoD) estimation, or joint AoD and multiple round trip time (multi-RTT)). In some aspects, special resource configuration may be configured and transmitted to handle joint positioning approaches. Such special resource configurations may account for UE capability and hardware limitations to handle two or more positioning models/approaches. A plurality of positioning models may be leveraged to serve multiple objectives, for example by enhancing positioning estimations for timing measurement(s), line-of-sight (LOS) indicator(s), angle(s), etc. A UE may be configured to indicate corresponding capabilities, complexity, and/or processing/gap conditions to enable joint operation of two or more positioning models by the same UE on the same set of positioning signals received by the UE. The UE may receive corresponding configurations regarding resources, when to prioritize one or more of the positioning models, when to prioritize one or more of the input measurements, when to prioritize one or more of the outputs, and/or whether the UE may accept positioning models from a network entity (e.g., an LMF, an over the top (OTT) server).

Particular aspects of the subject matter described in this disclosure can be implemented to realize one or more of the following potential advantages. In some examples, by enabling a network node and/or a UE to register a positioning model via a positioning model ID, the described techniques can be used to improve LCM operations between a network node and the UE. Identifying relevant or associated positioning models via messages may use less data or information elements (IE), conserving bandwidth. In some examples, by enabling a UE to process a set of inputs using a plurality of positioning models, a network may enhance positioning estimations and improve the quality of positioning reports generated/calculated by such UEs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

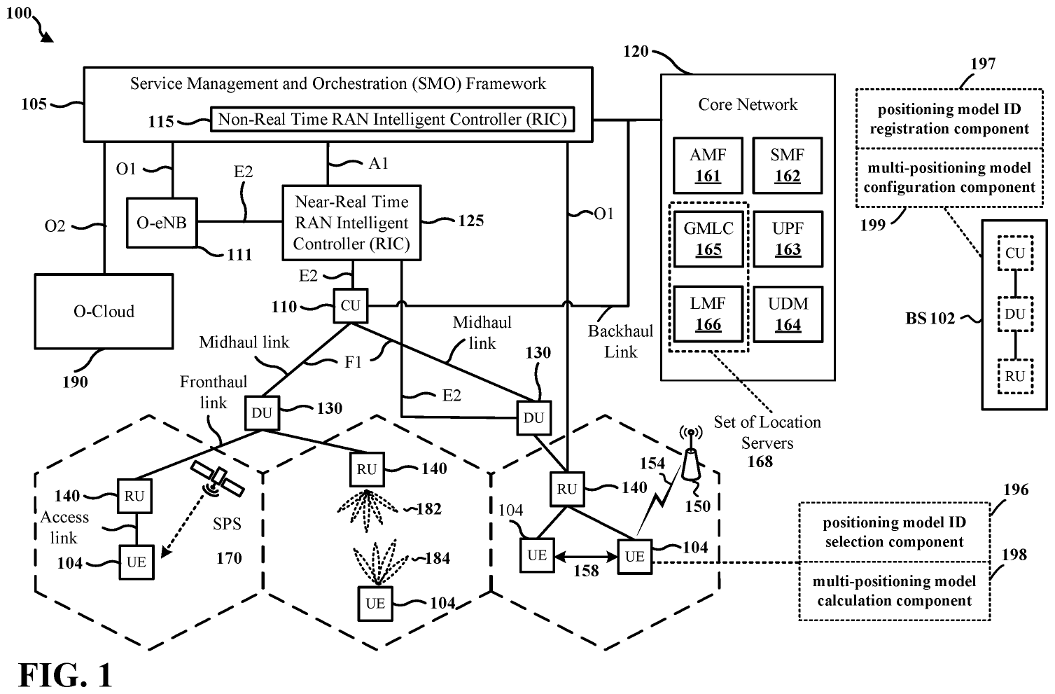

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage conditions that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a positioning model ID selection component 196 that may be configured to receive a positioning model registration message. The positioning model registration message may include a set of positioning model IDs and an indicator of a set of positioning model configurations. Each of the set of positioning model IDs may be associated with at least one of the set of positioning model configurations. The positioning model ID selection component 196 may be configured to receive a set of positioning signals. The positioning model ID selection component 196 may be configured to measure the set of positioning signals. The positioning model ID selection component 196 may be configured to select a positioning model ID from the set of positioning model IDs based on the set of positioning model configurations and an environmental attribute of the UE 104. The positioning model ID selection component 196 may be configured to calculate a set of positioning model outputs based on the measured set of positioning signals and a positioning model associated with the selected positioning model ID. In certain aspects, the base station 102 may have a positioning model ID registration component 197 that may be configured to register a set of positioning model IDs and a set of positioning model configurations with a positioning model ID database such that each of the set of positioning model IDs is associated with at least one of the set of positioning model configurations in the positioning model ID database. The positioning model ID registration component 197 may be configured to transmit a positioning model registration message. The positioning model registration message may include the registered set of positioning model IDs and an indicator of the registered set of positioning model configurations.

Referring again to FIG. 1, in certain aspects, the UE 104 may have a multi-positioning model calculation component 198 that may be configured to receive a positioning configuration. The positioning configuration may include an indicator for the multi-positioning model calculation component 198 to use a plurality of positioning models. The multi-positioning model calculation component 198 may be configured to receive a set of positioning signals. The multi-positioning model calculation component 198 may be configured to measure the set of positioning signals. The multi-positioning model calculation component 198 may be configured to calculate a first set of positioning model outputs based on a first positioning model of the plurality of positioning models and the measured set of positioning signals and a second set of positioning model outputs based on a second positioning model of the plurality of positioning models and the measured set of positioning signals. In certain aspects, the base station 102 may have a multi-positioning model configuration component 199 that may be configured to configure/calculate a positioning configuration. The positioning configuration may include an indicator for a UE, such as the UE 104, to use a plurality of positioning models on a set of positioning signals. The multi-positioning model configuration component 199 may be configured to transmit the positioning configuration. The positioning configuration may include an indicator for the set of positioning signals to be transmitted by a set of wireless devices (e.g., a set of transmission reception points (TRPs)) and/or received by the UE.

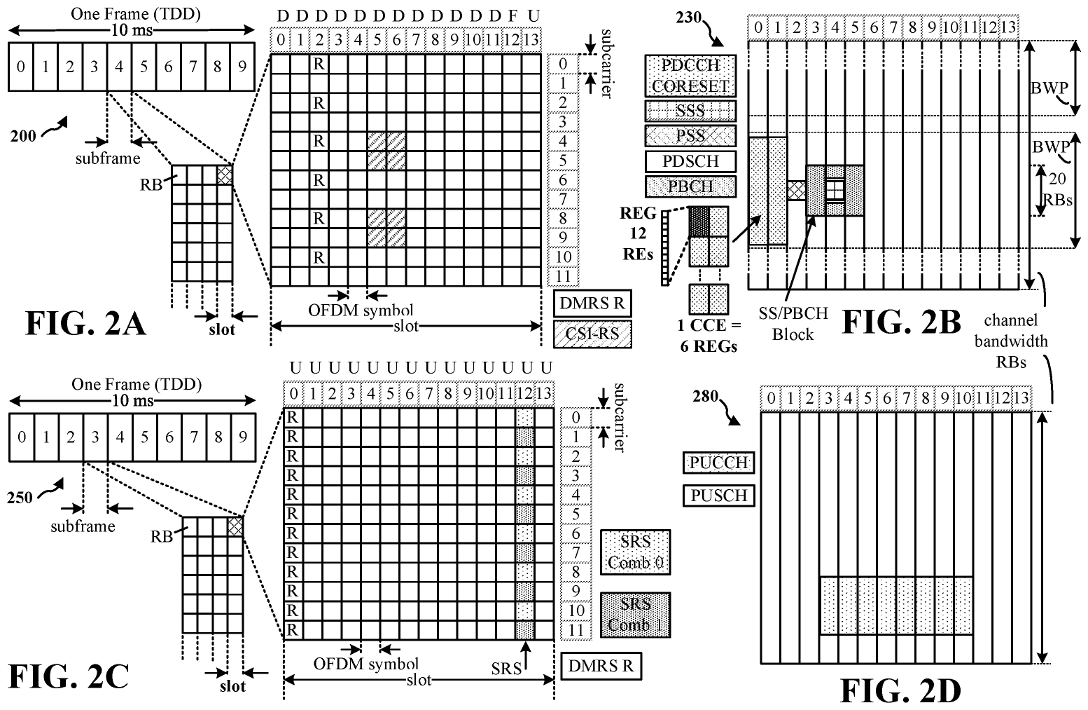

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

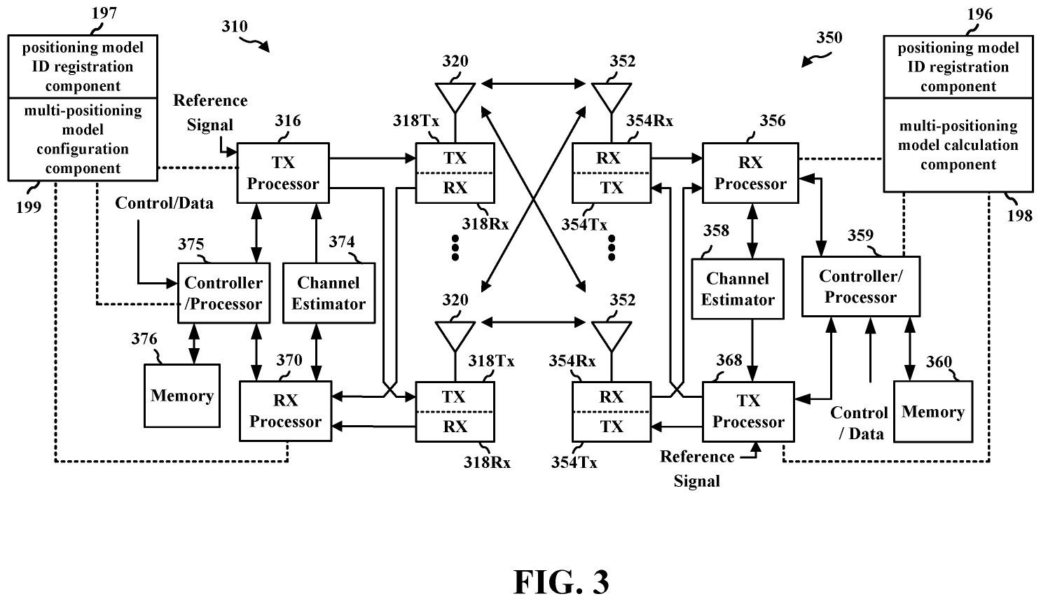

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the positioning model ID selection component 196 of FIG. 1.

At least one of the TX processor 368, the RX processor 356, and the controller/processor 359 may be configured to perform aspects in connection with the multi-positioning model calculation component 198 of FIG. 1.

At least one of the TX processor 316, the RX processor 370, and the controller/processor 375 may be configured to perform aspects in connection with the positioning model ID registration component 197 of FIG. 1.

At least one of the TX processor 316, the RX processor 370, and the controller/processor 375 may be configured to perform aspects in connection with the multi-positioning model configuration component 199 of FIG. 1.

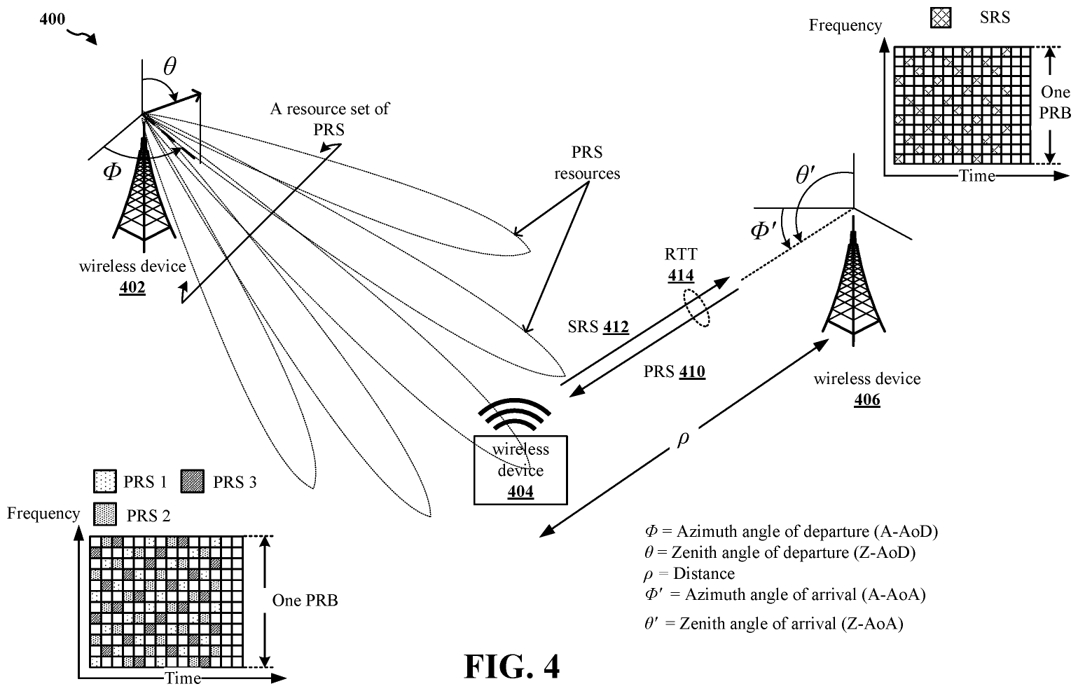

FIG. 4 is a diagram 400 illustrating an example of a positioning based on positioning signal measurements. A positioning signal may be any reference signal which may be measured to calculate a position attribute or a location attribute of a wireless device, for example a positioning reference signal (PRS), a sounding reference signal (SRS), a channel state information (CSI) reference signal (CSI-RS), or a synchronization and signal block (SSB). The wireless device 402 may be a base station, such as a TRP, or a UE with a known position/location, such as a positioning reference unit (PRU) or a UE with a high-accuracy sensor that may identify the location of the UE, for example a GNSS sensor or a GPS sensor. The wireless device 406 may be a base station or a UE with a known position/location. The wireless device 404 may be a UE or a TRP configured to perform positioning to gather data, for example to gather data to train an artificial intelligence machine learning (AI/ML or AIML) model, test positioning signal strength or test positioning noise attributes in an area. The wireless device 404 may transmit UL-SRS 412 at time T_{SRS_TX} and receive DL positioning reference signals (PRS) (DL-PRS) 410 at time T_{PRS_RX}. The wireless device 406 may receive the UL-SRS 412 at time T_{SRS_RX} and transmit the DL-PRS 410 at time T_{PRS_TX}. The wireless device 404 may receive the DL-PRS 410 before transmitting the UL-SRS 412, or may transmit the UL-SRS 412 before receiving the DL-PRS 410. In both cases, a positioning server (e.g., location server(s) 168, LMF 166) or the wireless device 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple wireless devices 402, 406 and measured by the wireless device 404, and the measured TRP Rx-Tx time difference measurements (i.e., |T_{SRS_RX}−T_{PRS_TX}|) and UL-SRS-RSRP at multiple wireless devices 402, 406 of uplink signals transmitted from wireless device 404. The wireless device 404 may measure the UE Rx-Tx time difference measurements (and optionally DL-PRS-RSRP of the received signals) using assistance data received from the positioning server, and the wireless devices 402, 406 may measure the gNB Rx-Tx time difference measurements (and optionally UL-SRS-RSRP of the received signals) using assistance data received from the positioning server. The measurements may be used at the positioning server or the wireless device 404 to determine the RTT. The RTT may be used to estimate the location of the wireless device 404. Other methods are possible for determining the RTT, such as for example using DL-TDOA and/or UL-TDOA measurements.

DL-AoD positioning may make use of the measured DL-PRS-RSRP of downlink signals received from multiple wireless devices 402, 406 at the wireless device 404. The wireless device 404 may measure the DL-PRS-RSRP of the received signals using assistance data received from the positioning server, and the resulting measurements may be used along with the azimuth angle of departure (A-AoD), the zenith angle of departure (Z-AoD), and/or other configuration information to locate the wireless device 404 in relation to the neighboring wireless devices 402, 406.

DL-TDOA positioning may make use of the DL reference signal time difference (RSTD) (and optionally DL-PRS-RSRP) of downlink signals received from multiple wireless devices 402, 406 at the wireless device 404. The wireless device 404 may measure the DL RSTD (and optionally DL-PRS-RSRP) of the received signals using assistance data received from the positioning server, and the resulting measurements may be used along with other configuration information to locate a position/location the wireless device 404 in relation to the neighboring wireless devices 402, 406.

UL-TDOA positioning may make use of the UL relative time of arrival (RTOA) (and optionally UL-SRS-RSRP) at multiple wireless devices 402, 406 of uplink signals transmitted from wireless device 404. The wireless devices 402, 406 may measure the UL-RTOA (and optionally UL-SRS-RSRP) of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices 402, 406 of uplink signals transmitted from the wireless device 404. The wireless devices 402, 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

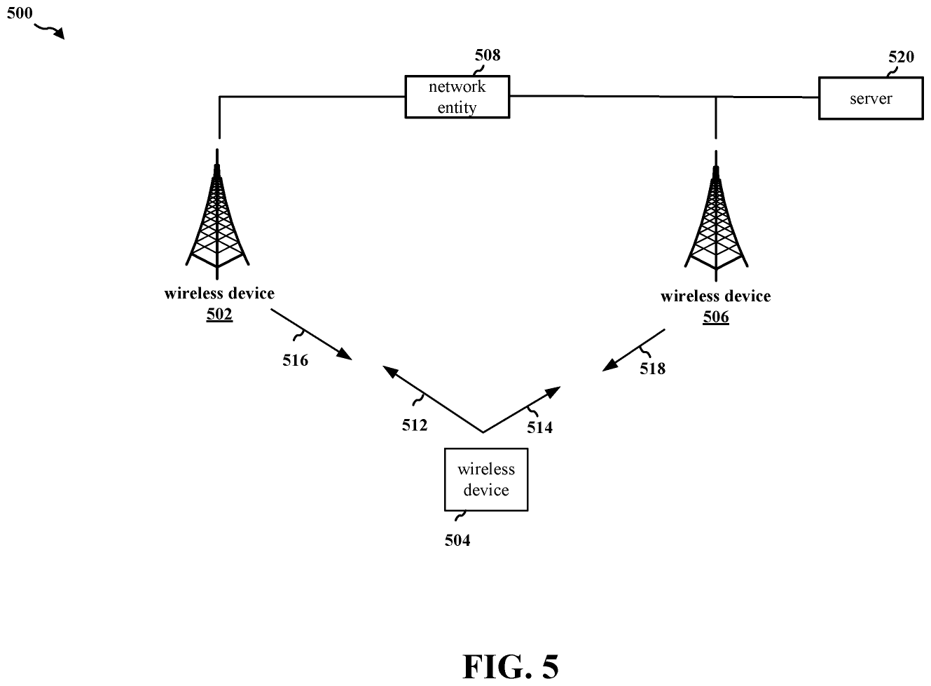

FIG. 5 is a diagram 500 illustrating a network entity 508 that may be configured to coordinate a wireless device 502 and a wireless device 506 to perform positioning with a wireless device 504. The location of the wireless device 502 and the wireless device 506 may be known to at least one of the devices, such as the wireless device 502, the wireless device 504, the wireless device 506, the network entity 508, and/or the server 520. The wireless device 502 may be a base station, a gNB, or a TRP. The wireless device 506 may be a base station, a gNB, or a TRP. The wireless device 504 may be a UE. In some aspects, the UE may be a PRU. A PRU may be a UE with a known location. For example, the PRU may be affixed in a known location or may be placed in a known location for a period of time, or the PRU may have a set of sensors (e.g., high-accuracy GNSS sensor) that may be used to accurately calculate the location of the PRU. In some aspects, the wireless device 504 may be a PRU configured to train a positioning model based on a set of inputs and a set of labels. In some aspects, the wireless device 504 may be a UE configured to use a positioning model to calculate a set of outputs based on a set of inputs, for example measurements of positioning signals. The network entity 508 may be connected to the wireless device 502 and the wireless device 506 via a physical link, for example a backhaul link or a midhaul link, or via a wireless link, such as an air interface (a UE-UTRAN (Uu)) link. The network entity 508 may be part of a core network, such as an LMF or a set of location servers. The network entity 508 may configure positioning occasions between the wireless device 502, the wireless device 504, and the wireless device 506. The server 520 may be an over-the-top (OTT) server or some other server functionally connected to a network that communicates with the network entity 508, the wireless device 502 and/or the wireless device 506, and/or with the wireless device 504 via a wireless device, such as the wireless device 502 and/or the wireless device 506. The server 520 may have storage for storing positioning models, for example AI/ML positioning models, trained using sets of positioning signals received by a wireless device, such as the wireless device 502, the wireless device 504, and/or the wireless device 506.

To perform positioning, the network entity 508 may configure one or more of the wireless devices to transmit positioning signals at one another. For example, the wireless device 504 may transmit the set of positioning signals 512 at the wireless device 502. The set of positioning signals 512 may be a set of SRSs, SSBs, or CSI-RSs. The wireless device 502 may measure the set of positioning signals 512. The wireless device 502 may transmit the set of positioning signals 516 at the wireless device 504. The set of positioning signals 516 may be a set of PRSs, SSBs, or CSI-RSs. The wireless device 504 may measure the set of positioning signals 516. The wireless device 504 may transmit a set of positioning signals 514 at the wireless device 506. The set of positioning signals 514 may be a set of SRSs, SSBs, or CSI-RSs. The wireless device 506 may measure the set of positioning signals 514. The wireless device 506 may transmit a set of positioning signals 518 at the wireless device 504. The set of positioning signals 518 may be a set of PRSs, SSBs, or CSI-RSs. The wireless device 504 may measure the set of positioning signals 518. One or more of the wireless devices may measure the received positioning signals to calculate a positioning measurement that may be used to calculate a position/location of the wireless device 504, or may be used to calculate a position/location of the wireless device 504. For example, if the location of the wireless device 502 and the location of the wireless device 506 are known, the location of the wireless device 504 may be calculated based on a RTT between the wireless device 502 and the wireless device 504, and a RTT between the wireless device 504 and the wireless device 506. In another example, the wireless device 504 may calculate an angle of arrival (AoA) or an angle of departure (AoD) of the set of positioning signals 516, and may calculate an AoA or an AoD of the set of positioning signals 518. The calculated AoAs and/or AoDs may be used to calculate a position of the wireless device 504 if the location of the wireless device 502 and the location of the wireless device 506 are also known. Other measurements, such as RTOA, line-of-sight (LOS) identification (identifying whether there is a direct line-of-sight path between wireless devices), or multi-cell round trip time (multi-RTT) calculations may be performed to calculate the position of the wireless device 504, or to calculate a measurement that may be used to calculate the position of the wireless device 504.

In some aspects, a positioning model may be used to calculate one or more positioning metrics based on the measurements. For example, based on the measurements of the set of positioning signals 512 and/or the set of positioning signals 514 transmitted by the wireless device 504, a position/location of the wireless device 504 may be calculated or estimated, or an intermediate measurement that may be used to calculate the position/location of the wireless device 504 may be calculated or estimated. A positioning model may be trained using artificial intelligence (AI)/machine learning (ML) (AI/ML or AIML), based on a set of inputs (e.g., measurements of positioning signals, assistance information associated with the positioning signals) and a set of labels. A positioning signal may include any reference signal transmitted from a wireless device, such as a PRS, a SRS, an SSB, or a CSI-RS. An RS transmitted from a UE, such as a PRU, may be referred to as an uplink positioning signal, or an UL positioning signal. An RS transmitted from a base station, or TRP, may be referred to as a downlink positioning signal, or a DL positioning signal. A measurement may be a channel delay profile (DP), a channel power delay profile (PDP), a channel impulse response (CIR), a channel frequency response (CFR), or other measurement used for performing positioning on a target wireless device. A label may be a calculated, derived, or given (i.e., known) expected result associated with a set of inputs, such as a position/location of a wireless device 504 or an intermediate measurement (e.g., a timing measurement, an angle measurement, a LOS identification) that may be used to calculate the position/location of the wireless device 504. A set of inputs and a set of labels may be used for generating and/or training a positioning model using AI/ML.

When training a positioning model, measurements of positioning signals as inputs, clean or noisy labels (clean labels may have a quality metric greater or equal to a threshold, noisy labels may have a quality metric less than or equal to the threshold) as expected outputs, and training data assistance information as inputs or expected outputs. The positioning model may operate on any wireless device based on a set of inputs. For example, the wireless device 502 may have a positioning model configured to accept a set of positioning measurements and generate an estimate of a position/location of the wireless device 504. In another example, the wireless device 502 may have a positioning model configured to accept a set of positioning measurements and generate an intermediate measurement (e.g., a timing measurement, an angle measurement, a LOS identification) that may be used (by the wireless device 502, or another entity, such as the network entity 508, the wireless device 504, or the wireless device 506) to calculate the position/location of the wireless device 504. In another example, the network entity 508 may have a positioning model configured to accept a set of positioning measurements and generate an estimate of a position/location of the wireless device 504, or generate an intermediate measurement that may be used to calculate the position/location of the wireless device 504. In another example, the wireless device 504 may have a positioning model configured to accept a set of positioning measurements and generate an estimate of a position/location of the wireless device 504, or generate an intermediate measurement that may be used to calculate the position/location of the wireless device 504. In some aspects, the positioning measurements may be aggregated by the entity with the positioning model, for example the network entity 508 may aggregate measurements of the set of positioning signals 512 from the wireless device 502, measurements of the set of positioning signals 514 the wireless device 506 to use as inputs to a positioning model, measurements of the set of positioning signals 516 from the wireless device 504, and/or measurements of the set of positioning signals 518 from the wireless device 504.

A positioning model may be trained on a wireless device that performs positioning, such as the wireless device 502, the wireless device 504, the wireless device 506, the network entity 508, and/or the server 520. The inputs to the positioning model may include measurements of positioning signals, such as measurements of SRS, PRS, SSB, and/or CSI-RS. The inputs to the measurements may include assistance information associated with the measured positioning signals, such as BWP of a positioning signal resource, number of TRPs, beam information, positioning signal configuration). The labels/outputs for the positioning model may include a location, or an intermediate measurement. In one aspect, the server 520 may be an OTT server configured to train and store positioning models. In another aspect, the network entity 508 may be configured to train and store positioning models. In other words, the server 520 or the network entity 508 may be a training entity configured to train positioning models based on input measurements taken by a wireless device, such as the wireless device 502, the wireless device 504, and/or the wireless device 506, and based on labels either known (e.g., stored on memory) or calculated by at least one of the wireless device 502, the wireless device 504, the wireless device 506, and/or the network entity 508. A positioning model may be configured to calculate a set of outputs. The set of outputs may include, for example, a reference signal time difference (RSTD), a line of sight (LOS) indicator (e.g., whether there exists a direct line-of-sight path between wireless devices, the likelihood of whether there exists a direct line-of-sight path between wireless devices), a multipath timing indicator (e.g., a time of flight per path, a time of arrival per path with respect to a timing mark), a multipath power indicator (e.g., strength of a signal per path), a multipath phase indicator (e.g., phase of a signal per path), a reference signal received power (RSRP), and/or an angle of departure (AoD).

In some aspects, a positioning model may be configured to use measurements of positioning signals transmitted from a wireless device to calculate a position of the wireless device 504, or to calculate an intermediate measurement that may be used to calculate the position of the wireless device 504. The positioning model may be trained via a training entity, and may be used at the wireless device 502, at the wireless device 504, at the wireless device 506, or at the network entity 508. For example, a positioning model at the wireless device 504 may be configured to calculate the location of the wireless device 504 based on measurements of the set of positioning signals 516 and/or the set of positioning signals 518. In another example, the wireless device 502 may transmit a set of intermediate measurements to the network entity 508 so that the network entity 508 may calculate the location of the wireless device 504 based on the set of intermediate measurements. In another example, the wireless device 504 may transmit measurements of the set of positioning signals 516 and/or the set of positioning signals 518 to the network entity 508. The positioning model may be at the network entity 508. The positioning model at the network entity 508 may calculate the location of the wireless device 504 based on the transmitted measurements of the set of positioning signals 516 and/or the set of positioning signals 518 from the wireless device 504, the transmitted measurements of the set of positioning signals 512 from the wireless device 502, and/or the transmitted measurements of the set of positioning signals 514 from the wireless device 506. In other words, any of the wireless device 502, the wireless device 504, and/or the wireless device 506 may assist the network entity 508 in performing positioning using a trained positioning model.

In some aspects, a positioning model may be site-specific. For example, a first positioning model may be trained in a location, or a set of locations, associated with a first site having a first set of borders, and a second positioning model may be trained in a location, or a set of locations, associated with a second site having a second set of borders. A wireless device may be configured to use one of a plurality of site-specific positioning models. For example, the wireless device may select a site-specific positioning model based on its location, or may select a site-specific positioning model based on an indicator, for example a signal transmitted from the network entity 508 that indicates that a particular site-specific positioning model from a plurality of site-specific positioning models be selected.

Measurements of positioning signals may be performed by measuring channels between a target device (e.g., the wireless device 504) and a set of network nodes (e.g., the wireless device 502 and the wireless device 506). The wireless device 504 may transmit a positioning signal, such as an SRS, an SSB, or a CSI-RS. The wireless device 502 and/or the wireless device 506 may measure the positioning signal for data collection purposes to train a positioning model. The wireless device 504 and/or the wireless device 506 may transmit a positioning signal, such as a PRS, an SSB, or a CSI-RS. The wireless device 504 may measure the positioning signal for data collection purposes to train the positioning model. The wireless device 502, the wireless device 504, and/or the wireless device 506 may measure a positioning signal resource in a plurality of ways, for example the measurement may be a channel impulse response (CIR), a channel frequency response (CFR), a power delay profile (PDP), a delay profile (DP), a set of reflection paths, a reception-transmission (Rx-Tx) time difference, a received signal strength indicator (RSSI), a reference signal received power (RSRP), a reference signal received power per path (RSRPP), a reference signal received quality (RSRQ), a time of arrival (ToA), a reference signal time difference (RSTD), or an angle of departure (AoD).

While the diagram 500 illustrates two positioning neighbor wireless devices, wireless device 502 and wireless device 506, configured to perform positioning with one positioning target wireless device, wireless device 504, to calculate a position/location of the wireless device 504, any number of positioning neighbor wireless devices may be configured to perform positioning with any number of positioning target wireless devices. For example, four positioning neighbor wireless devices may be configured to calculate the position/location of two positioning target wireless devices, three positioning neighbor wireless devices may be configured to calculate the position/location of one positioning target wireless device, or two positioning neighbor wireless devices may be configured to calculate the position/location of one positioning target wireless device.

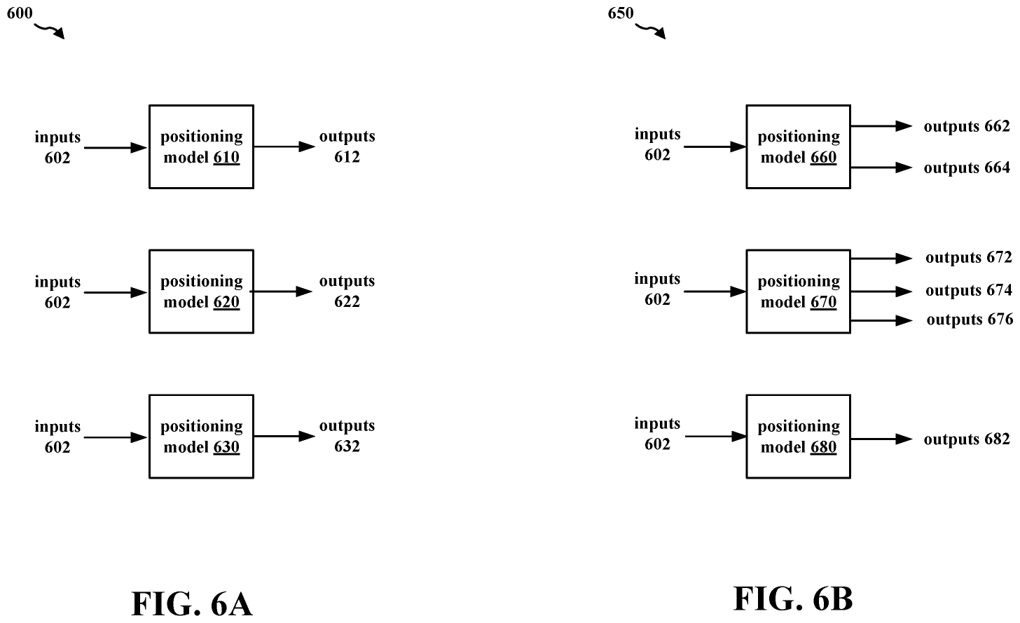

FIG. 6A is a diagram 600 illustrating an example of a plurality of positioning models configured to process a set of inputs to calculate a set of outputs. A wireless device, such as a UE or a network node, may be configured to utilize at least one of the positioning models to calculate a set of outputs. For example, a UE may be configured to select the positioning model 610 to calculate the set of outputs 612 based on the set of inputs 602, to select the positioning model 620 to calculate the set of outputs 622 based on the set of inputs 602, or to select the positioning model 630 to calculate the set of outputs 632 based on the set of inputs 602. The UE may select one of the positioning models based on a positioning model ID associated with the positioning model. In some aspects, a positioning configuration may designate which positioning model the UE will use based on a positioning model ID indicated in a configuration message. In some aspects, a wireless device may be configured to utilize a plurality of the positioning models to calculate a set of outputs. For example, a UE may be configured to use both the positioning model 610 and the positioning model 620 to calculate the set of outputs 612 and the set of outputs 622 based on the set of inputs 602, to use both the positioning model 620 and the positioning model 630 to calculate the set of outputs 622 and the set of outputs 632 based on the set of inputs 602, to use both the positioning model 610 and the positioning model 630 to calculate the set of outputs 612 and the set of outputs 632 based on the set of inputs 602, or to use each of the positioning model 610, the positioning model 620, and the positioning model 630 to calculate the set of outputs 612, the set of outputs 622, and the set of outputs 632 based on the set of inputs 602.

The set of inputs 602 may include a set of measurements taken by a wireless device. The set of measurements may include, for example PRS measurements or SRS measurements of any suitable type (e.g., CFR, CIR, PDP, DP). The set of outputs 612, the set of outputs 622, and the set of outputs 632 may be of different types from one another. For example, the set of outputs 612 may include an RSTD, a ToA, and/or an RTT, while the set of outputs 622 may include an RSRP and/or an AoD, while the set of outputs 632 may include an LOS indicator. A wireless device may run a two or more of the plurality of positioning models simultaneously to obtain joint positioning information generated by two or more of the plurality of positioning models. Each of the positioning models may be configured to generate one output. Each of the positioning models may be configured to generate multiple outputs. In some aspects, a wireless device may have two positioning models that both produce the same type of output, for example the set of outputs 612 may include an RSRP and the set of outputs 622 may include an RSRP. A wireless device may select between the two positioning models based on an environment that the wireless device is in (e.g., a first positioning model used at a first elevation and a second positioning model used at a second elevation). While the diagram 600 illustrates three positioning models, a wireless device may be configured to use more or less than three positioning models in other aspects.

FIG. 6B is a diagram 650 illustrating an example of a plurality of positioning models configured to process a set of inputs to calculate a set of outputs. A wireless device, such as a UE or a network node, may be configured to utilize at least one of the positioning models to calculate a set of outputs. For example, a UE may be configured to select the positioning model 660 to calculate the set of outputs 662 and the set of outputs 664 based on the set of inputs 602, may be configured to select the positioning model 670 to calculate the set of outputs 672, the set of outputs 674, and the set of outputs 676 based on the set of inputs 602, to select the positioning model 680 to calculate the set of outputs 682 based on the set of inputs 602. The UE may select one of the positioning models based on a positioning model ID associated with the positioning model. In some aspects, a positioning configuration may designate which positioning model the UE will use based on a positioning model ID indicated in a configuration message. In some aspects, a wireless device may be configured to utilize a plurality of the positioning models to calculate a set of outputs. For example, a UE may be configured to use both the positioning model 660 and the positioning model 670 to calculate the set of outputs 662, the set of outputs 664, the set of outputs 672, the set of outputs 674, and the set of outputs 676 based on the set of inputs 602, to use both the positioning model 670 and the positioning model 680 to calculate the set of outputs 672, the set of outputs 674, the set of outputs 676, and the set of outputs 682 based on the set of inputs 602, to use both the positioning model 660 and the positioning model 680 to calculate the set of outputs 662, the set of outputs 664, and the set of outputs 682 based on the set of inputs 602, or to use each of the positioning model 660, the positioning model 670, and the positioning model 680 to calculate the set of outputs 662, the set of outputs 664, the set of outputs 672, the set of outputs 674, the set of outputs 676, and the set of outputs 682 based on the set of inputs 602.

The set of inputs 602 may include a set of measurements taken by a wireless device. The set of measurements may include, for example PRS measurements or SRS measurements of any suitable type (e.g., CFR, CIR, PDP, DP). At least two of the set of outputs 662, the set of outputs 664, the set of outputs 672, the set of outputs 674, the set of outputs 676, and the set of outputs 682 may be of different types from one another. For example, the set of outputs 662 may include an RSTD, a ToA, and/or an RTT, while the set of outputs 664 may include an LOS indicator. Similarly, the set of outputs 672 may include an RSTD, a ToA, and/or an RTT, the set of outputs 674 may include an RSRP and/or an AoD, and the set of outputs 66 may include an LOS indicator. Similarly, the set of outputs 682 may include an RSRP and/or an AoD. A wireless device may run a two or more of the plurality of positioning models simultaneously to obtain joint positioning information generated by two or more of the plurality of positioning models, where each positioning model may produce one or more sets of outputs. Each of the positioning models may be configured to generate one or more outputs. In some aspects, a wireless device may have two positioning models that both produce the same type of output, for example the set of outputs 664 may include an LOS indicator and the set of outputs 676 may include an LOS indicator. A wireless device may select between the two positioning models based on an environment that the wireless device is in (e.g., a first positioning model used at a first elevation and a second positioning model used at a second elevation). In some aspects, the wireless device may use both positioning models to generate the same type of output at both positioning models, and may select one output over the other based on a threshold (e.g., based on an accuracy likelihood metric calculated by the positioning model) or may calculate a function of both outputs (e.g., an average of both outputs, a weighted average of both outputs). While the diagram 650 illustrates three positioning models, a wireless device may be configured to use more or less than three positioning models in other aspects.

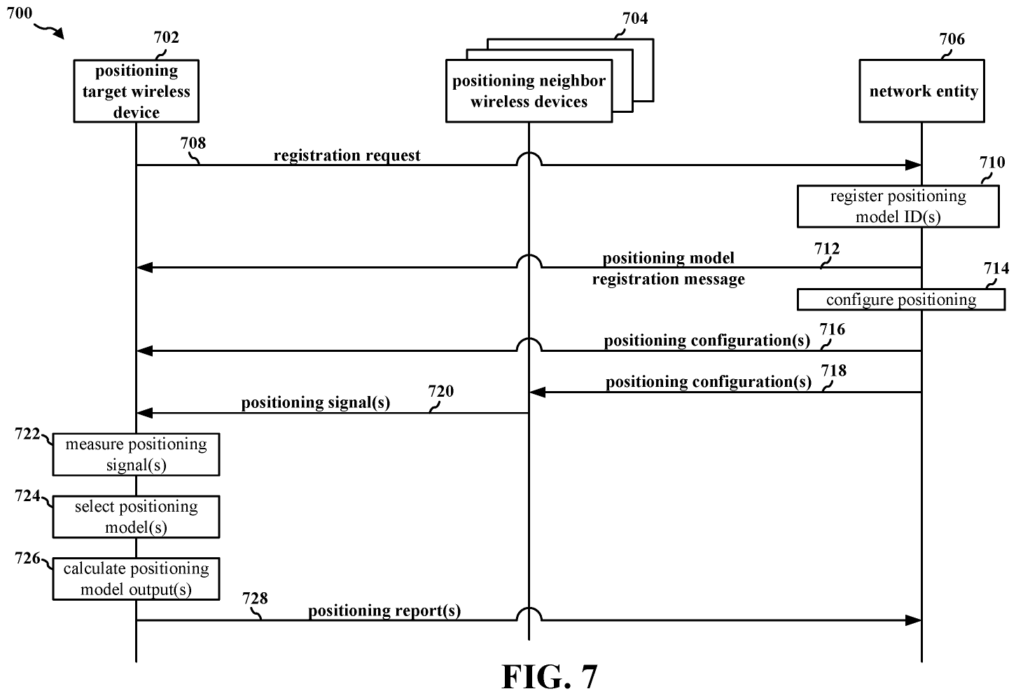

FIG. 7 is a connection flow diagram 700 illustrating an example of a network entity 706 configured to register a set of positioning model IDs based on a request from a positioning target wireless device 702. The positioning target wireless device 702 may be a UE or a PRU. The set of positioning neighbor wireless devices 704 may include a set of base stations and/or a set of TRPs. The network entity 706 may include an LMF or a set of location servers.

The positioning target wireless device 702 may transmit a registration request 708 to the network entity 706. The network entity 706 may receive the registration request 708 from the positioning target wireless device 702. The registration request 708 may include an indicator for a request for the positioning target wireless device 702 to register a positioning model ID with a positioning model. The registration request 708 may include a set of potential IDs that may be used to register a positioning model. In other words, the registration request 708 may suggest IDs to the network entity 706 to use to register positioning models which may be used at the positioning target wireless device 702. The registration request 708 may include initial model IDs suggested by the positioning target wireless device 702. The registration request 708 may include an area or a region for a positioning model to be registered. The registration request 708 may include a time period and/or duration (e.g., start time and duration) for a positioning model to be registered. The registration request 708 may include a number of IDs that the positioning target wireless device 702 is requesting which may be registered for a set of positioning models. The registration request 708 may include a globality indicator (e.g., global, network, area, UE-vendor) associated with a positioning model to be registered.

At 710, the network entity 706 may register a positioning model with the positioning model ID indicated in the registration request 708. The network entity 706 may register the positioning model with a database indicated by the registration request 708. The network entity 706 may select a database to register the positioning model based on other attributes, for example an area associated with the positioning model or a time period associated with the positioning model. The network entity 706 may register the positioning model in a database for an entire planet (i.e., the ID is unique for any positioning model in the world, or on planet Earth), in a database for a network (i.e., the ID is unique for any positioning model in a home network associated with the UE or with the network entity 706), in a database for an area (i.e., the ID is unique for any positioning model in a given area, for example San Diego or the United States), or in a database for a UE vendor (i.e., the ID is unique for any positioning model from the same UE vendor).

The network entity 706 may transmit a positioning model registration message 712 to the positioning target wireless device 702. The positioning target wireless device 702 may receive the positioning model registration message 712 from the network entity 706. The positioning model registration message 712 may include an indicator that the network entity 706 was successful at registering the positioning model ID at 710. The positioning model registration message 712 may indicate which model IDs were used to register the positioning model. The positioning model registration message 712 may indicate which database the model ID was registered with. The positioning model registration message 712 may indicate a spatial validity for the model IDs (e.g., areas within which the ID is valid). The positioning model registration message 712 may indicate a timing validity for the model IDs (e.g., periods of time, start/stop time, timer information).

At 714, the network entity 706 may configure positioning for the positioning target wireless device 702 and the set of positioning neighbor wireless devices 704. The configuration may include a configuration for the set of positioning neighbor wireless devices 704 to transmit a set of positioning signals 720 at the positioning target wireless device 702, and for the positioning target wireless device 702 to measure the set of positioning signals 720 received from the set of positioning neighbor wireless devices 704. The configuration may include a configuration for the positioning target wireless device 702 to use one or more positioning models to calculate a set of positioning model outputs based on positioning model IDs indicated by the network entity 706.

The network entity 706 may transmit a set of positioning configurations 716 at the positioning target wireless device 702. The positioning target wireless device 702 may receive the set of positioning configurations 716 from the network entity 706. The set of positioning configurations 716 may indicate for the positioning target wireless device 702 to use one or more positioning models to calculate a positioning model output at 726. The set of positioning configurations 716 may indicate the set of positioning models by a model ID. The network entity may transmit a set of positioning configurations 718 at the set of positioning neighbor wireless devices 704. The set of positioning neighbor wireless devices 704 may receive the set of positioning configurations 718 from the network entity 706. The set of positioning neighbor wireless devices 704 may transmit the signals 720 at the positioning target wireless device 702 based on the set of positioning configurations 718 received from the network entity 706.

At 722, the positioning target wireless device 702 may measure the set of positioning signals 720. At 724, the positioning target wireless device 702 may select one or more positioning models based on the set of positioning configurations 716. At 726, the positioning target wireless device 702 may calculate a set of positioning model outputs using the set of positioning models selected at 724. The positioning target wireless device 702 may select a set of positioning models to use at 726 based on a set of model IDs indicated by the set of positioning configurations 716.

The positioning target wireless device 702 may transmit a set of positioning reports 728 to the network entity 706. In some aspects, the positioning target wireless device 702 may transmit a single report that includes all of the outputs of all of the positioning models calculated at 726. In some aspects, the positioning target wireless device 702 may transmit one report for a subset of the positioning models selected at 724.

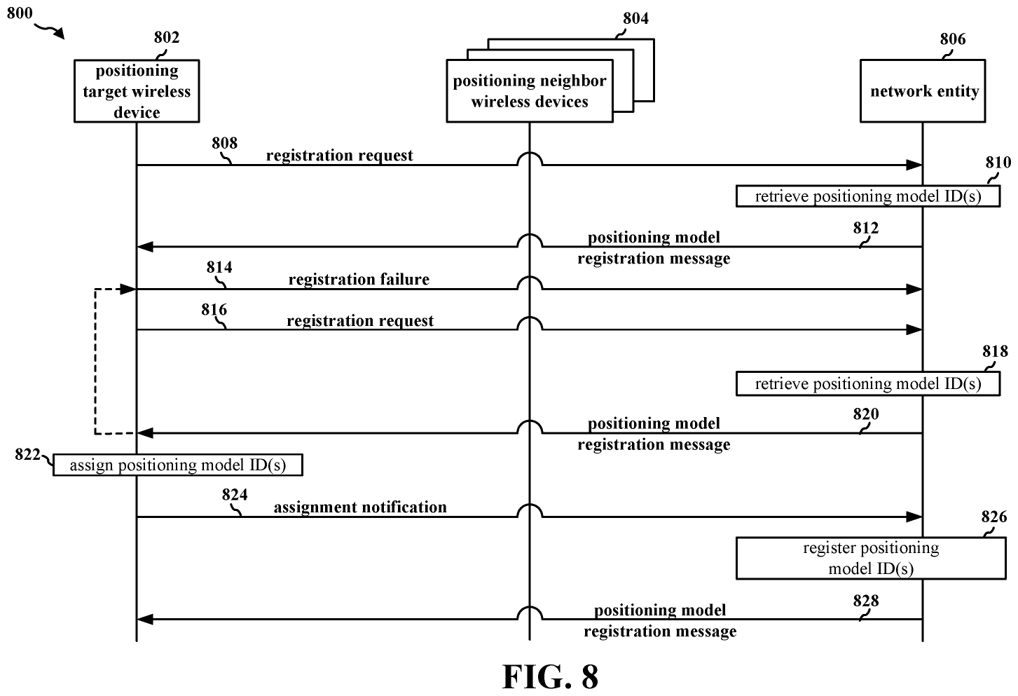

FIG. 8 is a connection flow diagram 800 illustrating an example of a network entity 806 configured to register a set of positioning model IDs based on a request from a positioning target wireless device 802. The positioning target wireless device 802 may be a UE or a PRU. The set of positioning neighbor wireless devices 804 may include a set of base stations and/or a set of TRPs. The network entity 806 may include an LMF or a set of location servers.

In some aspects, a positioning target wireless device 802 may assign a positioning model ID based on a set of potential positioning model IDs received from a network entity 806. The positioning target wireless device 802 may transmit a registration request 808 to the network entity 806. The network entity 806 may receive the registration request 808 from the positioning target wireless device 802. The registration request may include an indicator for a request for the positioning target wireless device 802 to assign a positioning model ID to a positioning model. The registration request may include an indicator for a request for network entity 806 to provide a set of potential positioning model IDs to the positioning target wireless device 802 for assignment to a set of positioning models. In other words, the registration request 808 may include an indicator of a request from the positioning target wireless device 802 to the network entity 806 for a set of potential positioning model IDs for the positioning target wireless device 802 to assign to one or more positioning models that may be used at the positioning target wireless device 802. At 810, the network entity 806 may retrieve a set of positioning model IDs from a source. In some aspects, the source may be at the network entity 806, for example where the network entity 806 has a database of positioning model IDs. In some aspects, the source may be at a remote device, for example a remote database that registers positioning model IDs. The database may include a global database that has unique positioning model IDs for all entities on a planet (e.g., planet Earth), a local database that has unique positioning model IDs for all entities in a region/area (e.g., in a country, in a state, in a county), a UE vendor database that has unique positioning model IDs for all entities that share a common UE vendor, or a UE category database that has unique positioning model IDs for all entities that share a common UE category (e.g., a common mobile phone model). The network entity 806 may transmit a positioning model registration message 812 to the positioning target wireless device 802. The positioning target wireless device 802 may receive the positioning model registration message 812 from the network entity 806. The positioning model registration message 812 may include an indicator of the set of potential positioning model IDs retrieved at 810.

In some aspects, the positioning target wireless device 802 may fail to register at least one of the set of potential positioning model IDs. For example, the positioning target wireless device 802 may have an indicator that one of the set of potential positioning model IDs is already associated with another positioning model. In response to determining that one of the set of potential positioning model IDs is invalid for assignment, the positioning target wireless device 802 may transmit a registration failure message 814 to the network entity 806. The network entity 806 may receive the registration failure message 814 from the positioning target wireless device 802. The registration failure message 814 may indicate to the network entity 806 that the positioning target wireless device 802 discovered an ID collision with another model ID. The registration failure message 814 may include an indicator for a request from the positioning target wireless device 802 to the network entity 806 of an updated model ID that does not have a collision issue. In some aspects, the network entity 806 may transmit a registration request 816 to the network entity 806. The registration request 816 may include an indicator for the network entity 806 to provide a new set of potential positioning model IDs.

At 818, the network entity 806 may retrieve a new set of potential positioning model IDs from a source. In some aspects, the source may the same source that was used at 810. In some aspects, the network entity 806 may report to the source that one of the previous set of potential positioning model IDs is invalid for assignment to a positioning model. The network entity 806 may transmit a positioning model registration message 820 to the positioning target wireless device 802. The positioning target wireless device 802 may receive the positioning model registration message 820 from the network entity 806. The positioning model registration message 820 may include an indicator of the new set of potential positioning model IDs retrieved at 818.

If one of the new set of potential positioning model IDs is invalid for registration, the positioning target wireless device 802 may, again, transmit a registration failure message 814 to the network entity 806. If each of the new set of potential positioning model IDs is valid for assignment, or if each of the original set of potential positioning model IDs is valid for assignment, at 822, the positioning target wireless device 802 may assign at least a subset of the potential positioning model IDs to a set of positioning models.

The positioning target wireless device 802 may transmit an assignment notification message 824 to the network entity 806. The network entity 806 may receive the assignment notification message 824 from the positioning target wireless device 802. The assignment notification message 824 may include an indicator of which of the potential positioning model IDs were used for assignment. In some aspects, the assignment notification message 824 may include an indicator of which positioning models were assigned to which of the potential positioning model IDs (e.g., an indicator of inputs used, an indicator of types of outputs, an indicator of region for which the positioning model is verified). At 826, the network entity 806 may register the positioning model IDs as used with a database. The network entity 806 may transmit a positioning model registration message 828 to the positioning target wireless device 802. The positioning target wireless device 802 may receive the positioning model registration message 828 from the network entity 806. The positioning model registration message 828 may include an indicator that the network entity 806 was successful at registering at least one positioning model ID at 826.

The positioning model registration message 828 may include an indicator of which model IDs were registered by the network entity 806. The positioning model registration message 828 may include an indicator of spatial validity attributes (e.g., area/region info) associated with the registered positioning models. The positioning model registration message 828 may include an indicator of timing validity attributes (e.g., timing start/stop times, timer information, time periods) associated with the registered positioning models. The positioning model registration message 828 may include an indicator of globality databases or globality attributes associated with the registered positioning models.

In some aspects, the positioning model registration message 828 may include an indicator of which positioning models are associated with the registered positioning model IDs. For example, the positioning model registration message 828 may include the actual positioning models, or may include links that the positioning target wireless device 802 may use to retrieve a registered positioning model from a data source.

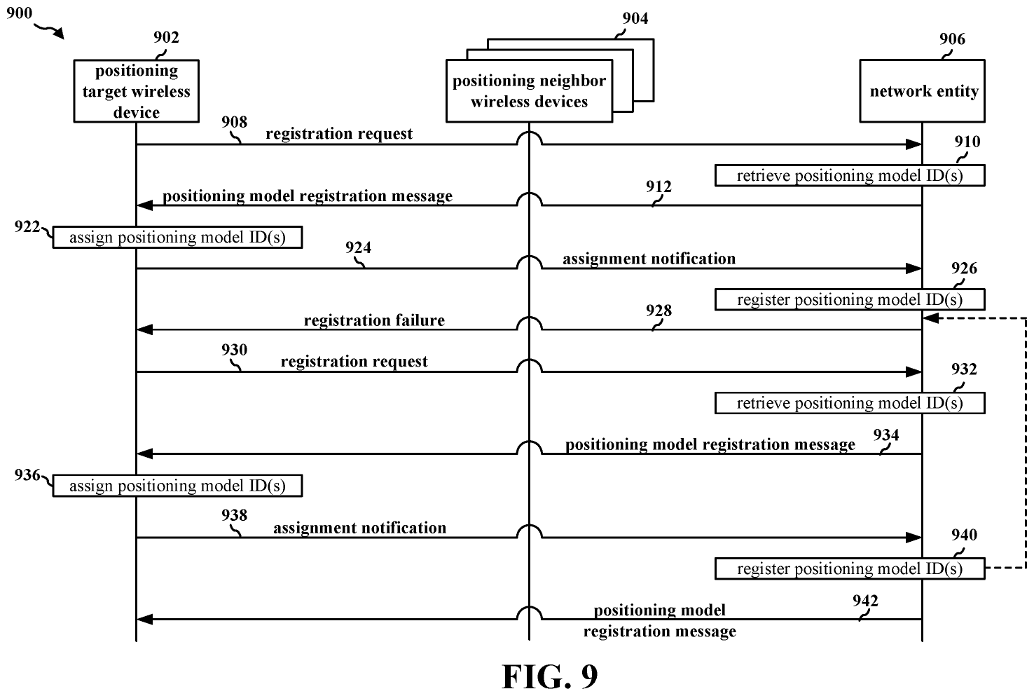

FIG. 9 is a connection flow diagram 900 illustrating an example of a network entity 906 configured to register a set of positioning model IDs based on a request from a positioning target wireless device 902. The positioning target wireless device 902 may be a UE or a PRU. The set of positioning neighbor wireless devices 904 may include a set of base stations and/or a set of TRPs. The network entity 906 may include an LMF or a set of location servers.

In some aspects, a network entity 906 may indicate to the positioning target wireless device 902 that a positioning model ID is invalid. Such a positioning model ID may have been assigned by the positioning target wireless device 902, may have been registered by the network entity 906, or may have been provided by the network entity 906 to the positioning target wireless device 902, for example in response to a registration request from the positioning target wireless device 902.

The positioning target wireless device 902 may transmit a registration request 908 to the network entity 906. The network entity 906 may receive the registration request 908 from the positioning target wireless device 902. The registration request may include an indicator for a request for the positioning target wireless device 902 to assign a positioning model ID to a positioning model. The registration request may include an indicator for a request for network entity 906 to provide a set of potential positioning model IDs to the positioning target wireless device 902 for assignment to a set of positioning models.

At 910, the network entity 906 may retrieve a set of positioning model IDs from a source. In some aspects, the source may be at the network entity 906, for example where the network entity 906 has a database of positioning model IDs. In some aspects, the source may be at a remote device, for example a remote database that registers positioning model IDs. The database may include a global database that has unique positioning model IDs for all entities on a planet (e.g., planet Earth), a local database that has unique positioning model IDs for all entities in a region/area (e.g., in a country, in a state, in a county), a UE vendor database that has unique positioning model IDs for all entities that share a common UE vendor, or a UE category database that has unique positioning model IDs for all entities that share a common UE category (e.g., a common mobile phone model). The network entity 906 may transmit a positioning model registration message 912 to the positioning target wireless device 902. The positioning target wireless device 902 may receive the positioning model registration message 912 from the network entity 906. The positioning model registration message 912 may include an indicator of the set of potential positioning model IDs retrieved at 910.

At 922, the positioning target wireless device 902 may assign at least a subset of the potential positioning model IDs to a set of positioning models. The positioning target wireless device 902 may transmit an assignment notification message 924 to the network entity 906. The network entity 906 may receive the assignment notification message 924 from the positioning target wireless device 902. The assignment notification message 924 may include an indicator of which of the potential positioning model IDs were used for assignment. In some aspects, the assignment notification message 924 may include an indicator of which positioning models were assigned to which of the potential positioning model IDs (e.g., an indicator of inputs used, an indicator of types of outputs, an indicator of region for which the positioning model is verified). At 926, the network entity 906 may register the positioning model IDs as used with a database. When attempting to register the positioning model IDs used, the network entity 906 may discover at that least some of the positioning model IDs are invalid for registration with a positioning model.

The network entity 906 may transmit a registration failure message 928 to the positioning target wireless device 902. The positioning target wireless device 902 may receive the registration failure message 928 from the network entity 906. The registration failure message 928 may include an indicator that the network entity 906 has determined that there exists a model ID collision with another model ID. The positioning target wireless device 902 may transmit a registration request 930 to the network entity 906. The network entity 906 may receive the registration request 930 from the positioning target wireless device 902. The registration request 930 may include an indicator for the network entity 906 to provide a new set of potential positioning model IDs to the positioning target wireless device 902 that does not include the invalid positioning model IDs.

At 932, the network entity 906 may retrieve a set of positioning model IDs from a source. The network entity 906 may transmit a positioning model registration message 934 to the positioning target wireless device 902. The positioning target wireless device 902 may receive the positioning model registration message 934 from the network entity 906. The positioning model registration message 934 may include an indicator of the new set of potential positioning model IDs retrieved at 932.

At 936, the positioning target wireless device 902 may assign at least a subset of the new potential positioning model IDs to a set of positioning models. The positioning target wireless device 902 may transmit an assignment notification message 938 to the network entity 906. The network entity 906 may receive the assignment notification message 938 from the positioning target wireless device 902. The assignment notification message 938 may include an indicator of which of the new potential positioning model IDs were used for assignment. In some aspects, the assignment notification message 938 may include an indicator of which positioning models were assigned to which of the potential positioning model IDs (e.g., an indicator of inputs used, an indicator of types of outputs, an indicator of region for which the positioning model is verified). At 940, the network entity 906 may register the positioning model IDs as used with a database. When attempting to register the positioning model IDs used, the network entity 906 may discover at that least some of the positioning model IDs are invalid for registration with a positioning model. If the network entity 906 determines that at least some of the positioning model IDs are invalid for registration with a positioning model, the network entity 906 may, again, transmit a registration failure message 928 to the positioning target wireless device 902.

If the network entity 906 determines that each of the positioning model IDs indicated in the assignment notification message 938 are valid for registration, the network entity 906 may transmit a positioning model registration message 942 to the positioning target wireless device 902. The positioning target wireless device 902 may receive the positioning model registration message 942 from the network entity 906. The positioning model registration message 942 may include an indicator that the network entity 906 was successful at registering at least one positioning model ID at 940.

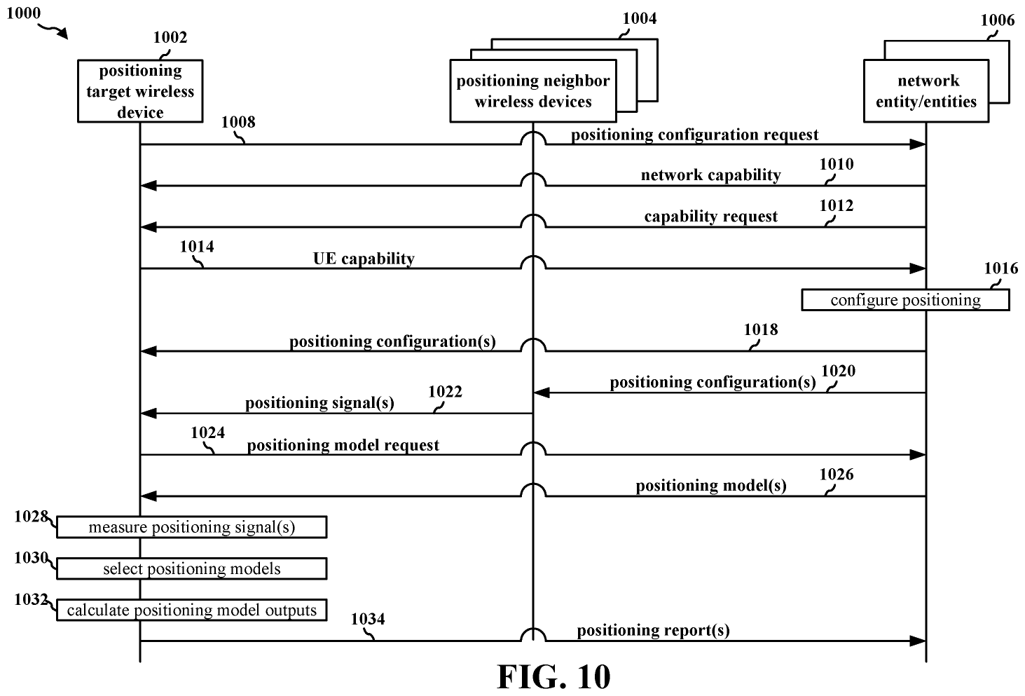

FIG. 10 is a connection flow diagram 1000 illustrating an example of a set of network entities 1006 configured to configure a positioning target wireless device 1002 to calculate a plurality of outputs based on a plurality of positioning models. The positioning target wireless device 1002 may be a UE or a PRU. The set of positioning neighbor wireless devices 1004 may include a set of base stations and/or a set of TRPs. The set of network entities 1006 may include an LMF, a set of location servers, a core network, and/or an OTT server.

The positioning target wireless device 1002 may transmit a positioning configuration request 1008 to the set of network entities 1006. The set of network entities 1006 may receive the positioning configuration request 1008 from the positioning target wireless device 1002. The positioning configuration request 1008 may include an indicator for the set of network entities 1006 to configure the positioning target wireless device 1002 to use a plurality of positioning models to calculate a plurality of outputs.

The set of network entities 1006 may transmit a network capability 1010 to the wireless device 1002. The wireless device 1002 may receive the network capability 1010 from the set of network entities 1006. The network capability 1010 may include an indicator that at least one of the set of network entities 1006 is capable of configuring the wireless device 1002 to use a plurality of positioning models on a common set of inputs.

In some aspects, the set of network entities 1006 may transmit a capability request 1012 to the wireless device 1002. The positioning target wireless device 1002 may receive the capability request 1012 from the set of network entities 1006. In response, the wireless device 1002 may transmit a UE capability 1014 to the set of network entities 1006. The set of network entities 1006 may receive the UE capability 1014 from the wireless device 1002. The UE capability 1014 may include an indicator that the wireless device 1002 is capable of using a plurality of positioning models to calculate a plurality of outputs using the same, or a common, set of inputs. The UE capability 1014 may include an indicator of what kinds of positioning output types the positioning target wireless device 1002 is capable of calculating using a plurality of positioning models. The positioning output types may include at least two of (a) an RSTD, (b) an LOS indicator, (c) a multipath timing indicator, (d) a multipath power indicator, (e) a multipath phase indicator, (f) an RSRP, or (g) an AoD. The UE capability 1014 may include an indicator of maximum resource configuration aspects that the positioning target wireless device 1002 may use for the plurality of positioning models. For example, the UE capability 1014 may indicate a maximum BW or a maximum number of measurement occasions that the positioning target wireless device 1002 is capable of using to measure positioning signals for a set of positioning models. The UE capability 1014 may include an indicator of conditional gaps for the positioning target wireless device 1002 to measure, process, and/or report the calculated positioning outputs. The UE capability 1014 may include an indicator of supported measurement and reporting aspects for the calculated positioning outputs, for example periodicity attributes. The UE capability 1014 may include an indicator of positioning models that the positioning target wireless device 1002 may use. Such positioning models may be indicated by model IDs. The UE capability 1014 may include an indicator of information on supported positioning model complexities, latency, and/or power consumption used by the positioning target wireless device 1002 to calculate a plurality of positioning outputs using a plurality of positioning models. The UE capability 1014 may include an indicator of whether the positioning target wireless device 1002 is capable of accepting positioning models from other devices (e.g., the set of network entities 1006). Such indicators may include indicators of memory conditions, processing conditions, and/or power consumption conditions, such as max limits. The positioning target wireless device 1002 may transmit an LPP message that includes the UE capability 1014. For example, the positioning target wireless device 1002 may transmit the UE capability 1014 as part of a capability procedure. The positioning target wireless device 1002 may transmit the UE capability 1014 in response to a request made by at least one of the set of network entities 1006.

At 1016, the set of network entities 1006 may configure positioning for the wireless device 1002. At least one of the set of network entities 1006 may configure positioning for the positioning target wireless device 1002 and the set of positioning neighbor wireless devices 1004. The configuration may include a configuration for the set of positioning neighbor wireless devices 1004 to transmit a set of positioning signals 1022 at the positioning target wireless device 1002, and for the positioning target wireless device 1002 to measure the set of positioning signals 1022 received from the set of positioning neighbor wireless devices 1004. The configuration may include a configuration for the positioning target wireless device 1002 to use two or more positioning models to calculate a set of positioning model outputs based on positioning models indicated by the set of network entities 1006.

The set of network entities 1006 may transmit a set of positioning configurations 1018 at the positioning target wireless device 1002. The positioning target wireless device 1002 may receive the set of positioning configurations 1018 from the set of network entities 1006. The set of positioning configurations 1018 may include an indicator for the positioning target wireless device 1002 to use a plurality of positioning models to calculate outputs based on the same set of positioning signals received by the positioning target wireless device 1002. The set of positioning configurations 1018 may include an indicator of the type of the positioning outputs for the positioning target wireless device 1002 to obtain. The positioning output types may include at least two of (a) an RSTD, (b) an LOS indicator, (c) a multipath timing indicator, (d) a multipath power indicator, (e) a multipath phase indicator, (f) an RSRP, or (g) an AoD. For example, the set of positioning configurations 1018 may include an indicator for the positioning target wireless device 1002 to obtain an RSTD and an LOS indicator. In another example, the set of positioning configurations 1018 may include an indicator for the positioning target wireless device 1002 to obtain 888. In another example, the set of positioning configurations 1018 may include an indicator for the positioning target wireless device 1002 to obtain multipath timing and power (RSRPP). In another example, the set of positioning configurations 1018 may include an indicator for the positioning target wireless device 1002 to obtain an RSTD and an RSRP/AoD. In another example, the set of positioning configurations 1018 may include an indicator for the positioning target wireless device 1002 to obtain an RSRP/AOD and an LOS indicator. In another example, the set of positioning configurations 1018 may include an indicator for the positioning target wireless device 1002 to obtain an RSTD, phase of the first path, LOS indicator, multipath timing, multipath power RSRPP, RSRP/AOD of the first path, and an AoD for a multipath. The set of positioning configurations 1018 may include resource configuration attributes for utilizing a plurality of positioning models on the same set of positioning signals. For example, the set of positioning configurations 1018 may include an indicator for the positioning target wireless device 1002 to use the same resource to obtain two or more positioning outputs from two or more positioning models. In another example, the set of positioning configurations 1018 may include an indicator for the positioning target wireless device 1002 to use different resources (possibly indicated by the set of positioning configurations 1018) for specified positioning outputs (e.g., use PRS with BW1 to obtain RSTD and PRS with BW2 to obtain RSRP). The set of positioning configurations 1018 may include indicators of measurement aspects for the set of positioning signals 1022. In other words, the set of positioning configurations 1018 may include indicators of how often to conduct measurements for using the plurality of positioning models. For example, the set of positioning configurations 1018 may indicate for the positioning target wireless device 1002 to conduct measurements periodically, aperiodically (e.g., dynamically on demand), and/or in response to detecting an event (e.g., detecting an SNR satisfying a threshold range, detecting a delay spread satisfying a threshold range). The set of positioning configurations 1018 may include indicators of reporting aspects for the positioning outputs based on the plurality of positioning models. For example, the set of positioning configurations 1018 may indicate for the positioning target wireless device 1002 to report calculated positioning outputs periodically, aperiodically, semi-statically, or in response to detecting an event. The set of positioning configurations 1018 may indicate for the positioning target wireless device 1002 to prioritize utilizing some measurements over others, for example RSTD more than LOS indicators, which are prioritized higher than RSRP. Such a configured positioning target wireless device 1002 may give priority to measuring RSTD if processing exceeds the capability of the positioning target wireless device 1002. The set of positioning configurations 1018 may indicate for the positioning target wireless device 1002 to prioritize calculating, or reporting, some positioning outputs over others, for example reporting measured RSTD over reporting LOS indicators, which is prioritized over reporting RSRP. The set of positioning configurations 1018 may indicate information that the positioning target wireless device 1002 may use to obtain at least one of the plurality of positioning models, for example by providing a link to an OTT server that may store at least one of the plurality of positioning models, which the positioning target wireless device 1002 may download the positioning model from. At least one of the set of network entities 1006 may transmit the set of positioning configurations 1018 in a long-term evolution (LTE) positioning protocol (LPP) message. The at least one of the set of network entities 1006 may transmit the set of positioning configurations 1018 in response to a request from the positioning target wireless device 1002. The at least one of the set of network entities 1006 may transmit the LPP message as a location provide message, assistance data message, broadcast message, or positioning system information block (posSIB) LPP message.

The network entity may transmit a set of positioning configurations 1020 at the set of positioning neighbor wireless devices 1004. The set of positioning neighbor wireless devices 1004 may receive the set of positioning configurations 1020 from the set of network entities 1006. The set of positioning neighbor wireless devices 1004 may transmit the signals 1022 at the positioning target wireless device 1002 based on the set of positioning configurations 1020 received from the set of network entities 1006.

In some aspects, the wireless device 1002 may not have at least some of the indicated positioning models. The wireless device 1002 may transmit a positioning model request 1024 to the set of network entities 1006, for example an LMF, an OTT server, or a positioning model database accessible via a network. The set of network entities 1006 may transmit a set of positioning models 1026 to the set of network entities 1006. The set of network entities 1006 may receive the set of positioning models 1026 from the set of network entities 1006.

At 1028, the positioning target wireless device 1002 may measure the set of positioning signals 1022. At 1030, the positioning target wireless device 1002 may select two or more positioning models based on the set of positioning configurations 1018. At 1032, the positioning target wireless device 1002 may calculate a set of positioning model outputs using the set of positioning models selected at 1030.

The positioning target wireless device 1002 may transmit a set of positioning reports 1034 to the set of network entities 1006. In some aspects, the positioning target wireless device 1002 may transmit a single report that includes all of the outputs of all of the positioning models calculated at 1032. In some aspects, the positioning target wireless device 1002 may transmit one report for each of the positioning models selected at 1028. In other words, the set of positioning reports 1034 may include joint positioning information.

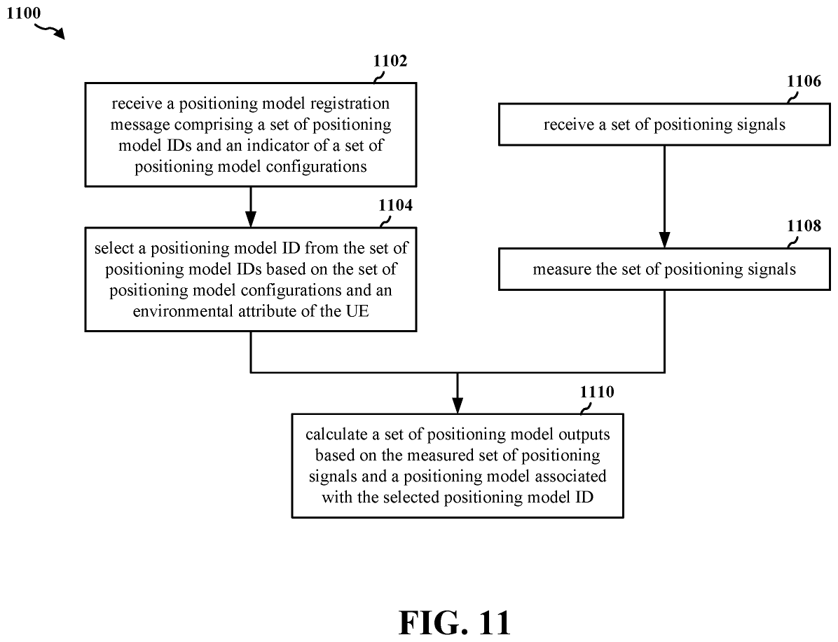

FIG. 11 is a flowchart 1100 of a method of wireless communication. The method may be performed by a UE (e.g., the UE 104, the UE 350; the wireless device 404, the wireless device 504; the positioning target wireless device 702, the positioning target wireless device 802, the positioning target wireless device 902, the positioning target wireless device 1002; the apparatus 1504). At 1102, the UE may receive a positioning model registration message including a set of positioning model IDs and an indicator of a set of positioning model configurations. For example, 1102 may be performed by the positioning target wireless device 702 in FIG. 7, which may receive a positioning model registration message including a set of positioning model IDs and an indicator of a set of positioning model configurations. Moreover, 1102 may be performed by the component 196 in FIG. 1, 3, or 15.

At 1104, the UE may select a positioning model ID from the set of positioning model IDs based on the set of positioning model configurations and an environmental attribute of the UE. For example, 1104 may be performed by the positioning target wireless device 702 in FIG. 7, which may select a positioning model ID from the set of positioning model IDs based on the set of positioning model configurations and an environmental attribute of the UE. Moreover, 1104 may be performed by the component 196 in FIG. 1, 3, or 15.

At 1106, the UE may receive a set of positioning signals. For example, 1106 may be performed by the positioning target wireless device 702 in FIG. 7, which may receive a set of positioning signals. Moreover, 1106 may be performed by the component 196 in FIG. 1, 3, or 15.

At 1108, the UE may measure the set of positioning signals. For example, 1108 may be performed by the positioning target wireless device 702 in FIG. 7, which may measure the set of positioning signals. Moreover, 1108 may be performed by the component 196 in FIG. 1, 3, or 15.

At 1110, the UE may calculate a set of positioning model outputs based on the measured set of positioning signals and a positioning model associated with the selected positioning model ID. For example, 1110 may be performed by the positioning target wireless device 702 in FIG. 7, which may calculate a set of positioning model outputs based on the measured set of positioning signals and a positioning model associated with the selected positioning model ID. Moreover, 1110 may be performed by the component 196 in FIG. 1, 3, or 15.

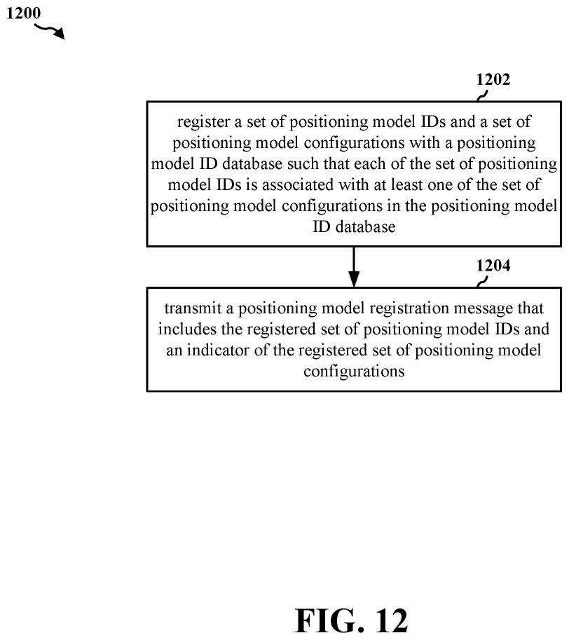

FIG. 12 is a flowchart 1200 of a method of wireless communication. The method may be performed by a network entity (e.g., the base station 102, the base station 310; the LMF 166; the one or more location servers 168; the core network 120; the wireless device 402, the wireless device 406, the wireless device 502, the wireless device 506; the server 520; the network entity 508, the network entity 706, the network entity 806, the network entity 906, the network entity 1502, the network entity 1602, the network entity 1760; the set of network entities 1006). At 1202, the network entity may register a set of positioning model IDs and a set of positioning model configurations with a positioning model ID database such that each of the set of positioning model IDs is associated with at least one of the set of positioning model configurations in the positioning model ID database. For example, 1202 may be performed by the network entity 706 in FIG. 7, which may register a set of positioning model IDs and a set of positioning model configurations with a positioning model ID database such that each of the set of positioning model IDs is associated with at least one of the set of positioning model configurations in the positioning model ID database. Moreover, 1202 may be performed by the component 197 in FIG. 1, 3, 16, or 17.

At 1204, the network entity may transmit a positioning model registration message that includes the registered set of positioning model IDs and an indicator of the registered set of positioning model configurations. For example, 1204 may be performed by the network entity 706 in FIG. 7, which may transmit a positioning model registration message that includes the registered set of positioning model IDs and an indicator of the registered set of positioning model configurations. Moreover, 1204 may be performed by the component 197 in FIG. 1, 3, 16, or 17.

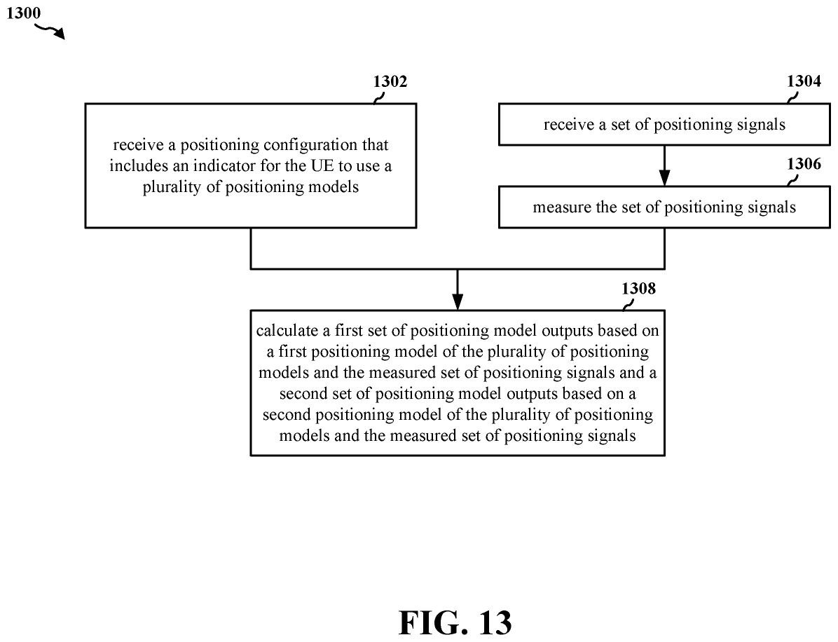

FIG. 13 is a flowchart 1300 of a method of wireless communication. The method may be performed by a UE (e.g., the UE 104, the UE 350; the wireless device 404, the wireless device 504; the positioning target wireless device 1002, the positioning target wireless device 802, the positioning target wireless device 902, the positioning target wireless device 1002; the apparatus 1504). At 1302, the UE may receive a positioning configuration that includes an indicator for the UE to use a plurality of positioning models. For example, 1302 may be performed by the positioning target wireless device 1002 in FIG. 10, which may receive a positioning configuration that includes an indicator for the UE to use a plurality of positioning models. Moreover, 1302 may be performed by the component 198 in FIG. 1, 3, or 15.

At 1304, the UE may receive a set of positioning signals. For example, 1304 may be performed by the positioning target wireless device 1002 in FIG. 10, which may receive a set of positioning signals. Moreover, 1304 may be performed by the component 198 in FIG. 1, 3, or 15.

At 1306, the UE may measure the set of positioning signals. For example, 1306 may be performed by the positioning target wireless device 1002 in FIG. 10, which may measure the set of positioning signals. Moreover, 1306 may be performed by the component 198 in FIG. 1, 3, or 15.

At 1308, the UE may calculate a first set of positioning model outputs based on a first positioning model of the plurality of positioning models and the measured set of positioning signals and a second set of positioning model outputs based on a second positioning model of the plurality of positioning models and the measured set of positioning signals. For example, 1308 may be performed by the positioning target wireless device 1002 in FIG. 10, which may calculate a first set of positioning model outputs based on a first positioning model of the plurality of positioning models and the measured set of positioning signals and a second set of positioning model outputs based on a second positioning model of the plurality of positioning models and the measured set of positioning signals. Moreover, 1308 may be performed by the component 198 in FIG. 1, 3, or 15.

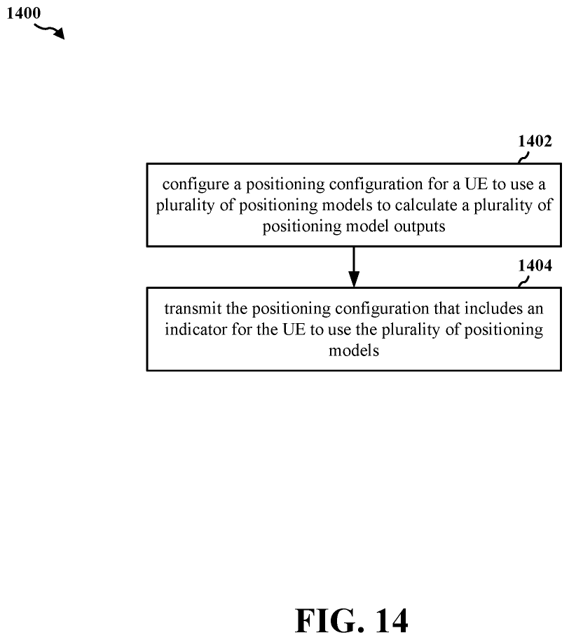

FIG. 14 is a flowchart 1400 of a method of wireless communication. The method may be performed by a network entity (e.g., the base station 102, the base station 310; the LMF 166; the one or more location servers 168; the core network 140; the wireless device 402, the wireless device 406, the wireless device 502, the wireless device 506; the server 520; the network entity 508, the set of network entities 1006, the network entity 806, the network entity 906, the network entity 1502, the network entity 1602, the network entity 1760; the set of network entities 1006). At 1402, the network entity may configure a positioning configuration for a UE to use a plurality of positioning models to calculate a plurality of positioning model outputs. For example, 1402 may be performed by the set of network entities 1006 in FIG. 10, which may configure a positioning configuration for a UE to use a plurality of positioning models to calculate a plurality of positioning model outputs. Moreover, 1402 may be performed by the component 197 in FIG. 1, 3, 16, or 17.

At 1404, the network entity may transmit the positioning configuration that includes an indicator for the UE to use the plurality of positioning models. For example, 1404 may be performed by the set of network entities 1006 in FIG. 10, which may transmit the positioning configuration that includes an indicator for the UE to use the plurality of positioning models. Moreover, 1404 may be performed by the component 197 in FIG. 1, 3, 16, or 17.

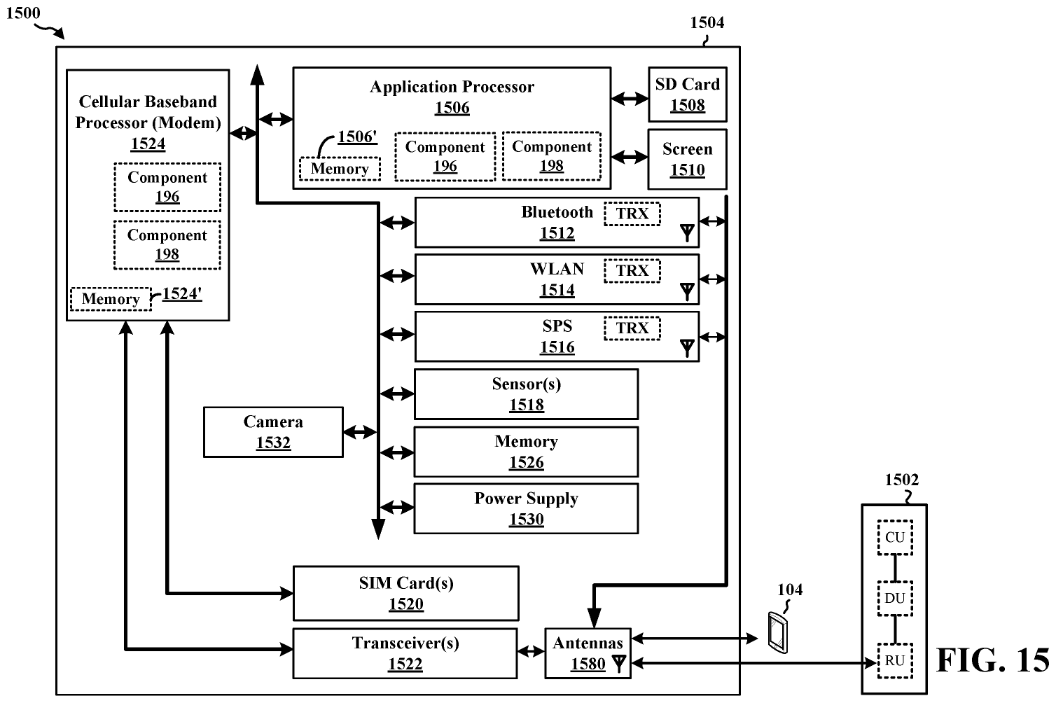

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 196 may be configured to receive a positioning model registration message. The positioning model registration message may include a set of positioning model IDs and an indicator of a set of positioning model configurations. Each of the set of positioning model IDs may be associated with at least one of the set of positioning model configurations. The component 196 may be configured to receive a set of positioning signals. The component 196 may be configured to measure the set of positioning signals. The component 196 may be configured to select a positioning model ID from the set of positioning model IDs based on the set of positioning model configurations and an environmental attribute of the apparatus 1504. The component 196 may be configured to calculate a set of positioning model outputs based on the measured set of positioning signals and a positioning model associated with the selected positioning model ID. The component 196 may be within the cellular baseband processor(s) 1524, the application processor(s) 1506, or both the cellular baseband processor(s) 1524 and the application processor(s) 1506. The component 196 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving a positioning model registration message. The positioning model registration message may include a set of positioning model IDs and/or an indicator of a set of positioning model configurations. Each of the set of positioning model IDs may be associated with at least one of the set of positioning model configurations. The apparatus 1504 may include means for receiving a set of positioning signals; measuring the set of positioning signals. The apparatus 1504 may include means for selecting a positioning model ID from the set of positioning model IDs based on the set of positioning model configurations and an environmental attribute of the apparatus 1504. The apparatus 1504 may include means for calculating a set of positioning model outputs based on the measured set of positioning signals and a positioning model associated with the selected positioning model ID. The apparatus 1504 may include means for transmitting a request message before the reception of the positioning model registration message. The request message may include a request for the positioning model registration message. The request message may include a set of potential IDs. A first subset of the set of positioning model IDs may include a second subset of the set of potential IDs. The request message may include a set of potential positioning model configurations. A first subset of the set of positioning model configurations may include a second subset of the set of potential positioning model configurations. Each of the set of potential positioning model configurations may include at least one of (a) a suggested area for a suggested positioning model, (b) a suggested time period for the suggested positioning model, (c) a suggested duration for the suggested positioning model, or (d) a suggested globality database for the suggested positioning model. The request message may include a second indicator of a number of requested model IDs. The set of positioning model IDs may include the number of requested model IDs. The positioning model registration message may include a second indicator of a globality database associated with the set of positioning model IDs and the set of positioning model configurations. The globality database may be associated with at least one of (a) a first positioning model ID database including a first set of unique model IDs for an entire planet, (b) a second positioning model ID database including a second set of unique model IDs for a network, (c) a third positioning model ID database including a third set of unique model IDs for an area, or (d) a fourth positioning model ID database including a fourth set of unique model IDs for a UE vendor. The apparatus 1504 may include means for transmitting a positioning model registration failure message. The positioning model registration failure message may include a second indicator of at least one of the set of positioning model IDs that is invalid for registration with the apparatus 1504. The apparatus 1504 may include means for receiving a second positioning model registration message. The second positioning model registration message may include a second set of positioning model IDs and a third indicator of the set of positioning model configurations. Each of the second set of positioning model IDs may be associated with at least one of the set of positioning model configurations. The second set of positioning model IDs may not include at least one of the set of positioning model IDs that is invalid for registration with the apparatus 1504. The second set of positioning model IDs may include the selected positioning model ID. The apparatus 1504 may include means for transmitting a request message before the reception of the second positioning model registration message. The request message may include a request for the second positioning model registration message. The apparatus 1504 may include means for transmitting a report message. The report message may include a second indicator of the selected positioning model ID and a third indicator of at least one of the calculated set of positioning model outputs. The apparatus 1504 may include means for receiving a positioning model registration failure message. The positioning model registration failure message may include a fourth indicator that the selected positioning model ID is invalid for registration. The apparatus 1504 may include means for receiving a second positioning model registration message. The second positioning model registration message may include a second set of positioning model IDs. Each of the second set of positioning model IDs may be associated with at least one of a second set of positioning model configurations. The second set of positioning model IDs may not include the selected positioning model ID. The apparatus 1504 may include means for transmitting a request message before the reception of the second positioning model registration message. The request message may include a request for the second positioning model registration message. The environmental attribute of the apparatus 1504 may include at least one of (a) an area associated with a calculated location of the apparatus 1504, (b) a region associated with the calculated location of the apparatus 1504, (c) a time period associated with a clock of the apparatus 1504, or (d) a duration associated with the clock of the apparatus 1504. The apparatus 1504 may include means for receiving a positioning configuration. The positioning configuration may include a second indicator of a plurality of positioning model IDs associated with a plurality of positioning models. The plurality of positioning model IDs may include the selected positioning model ID and a second positioning model ID. The apparatus 1504 may include means for selecting the positioning model ID by selecting the plurality of positioning model IDs from the set of positioning model IDs based on the positioning configuration. The apparatus 1504 may include means for calculating a second set of positioning model outputs based on the measured set of positioning signals and a second positioning model associated with the second positioning model ID. The apparatus 1504 may include means for transmitting a positioning report. The positioning configuration may include a report configuration for the positioning report. The report configuration may include at least one of (a) a timing for the transmission of the positioning report, (b) an event trigger associated with the transmission of the positioning report, or (c) a priority indicator for each of a plurality of positioning model outputs. The plurality of positioning model outputs may include the set of positioning model outputs and the second set of positioning model outputs. The positioning report may include a third indicator of the set of positioning model outputs and a fourth indicator of the second set of positioning model outputs. The apparatus 1504 may include means for transmitting a first positioning report. The first positioning report may include a third indicator of at least one of the set of positioning model outputs. The apparatus 1504 may include means for transmitting a second positioning report. The second positioning report may include a fourth indicator of at least one of the second set of positioning model outputs. The apparatus 1504 may include means for obtaining a set of measurement inputs. The apparatus 1504 may include means for obtaining a set of labels. The apparatus 1504 may include means for training the plurality of positioning models based on the set of measurement inputs and the set of labels using AI/ML. At least one of the set of positioning model outputs may include a first output type. At least one of the second set of positioning model outputs may include a second output type. The first output type and the second output type may be different. A plurality of output types may include the first output type and the second output type. The plurality of output types may include at least two of an RSTD, an LOS indicator, a multipath timing indicator, a multipath power indicator, a multipath phase indicator, an RSRP, or an AoD. The positioning configuration may include a third indicator of the first output type and a fourth indicator of the second output type. The positioning configuration may include (a) a third indicator of a first set of resources associated with the positioning model and the measured set of positioning signals and (b) a fourth indicator of a second set of resources associated with the second positioning model and the measured set of positioning signals. The apparatus 1504 may include means for calculating the set of positioning model outputs and the second set of positioning model outputs by (a) calculating the set of positioning model outputs further based on the first set of resources and (b) calculating the second set of positioning model outputs further based on the second set of resources. The first set of resources may include at least one of (a) a type of the set of positioning signals, (b) a BW of the set of positioning signals, (c) a timing of the set of positioning signals, or (d) an event trigger associated with the calculation of the set of positioning model outputs. The positioning configuration may include a third indicator of a set of resources associated with the positioning model, the second positioning model, and the measured set of positioning signals. The apparatus 1504 may include means for calculating the set of positioning model outputs and the second set of positioning model outputs by calculating the set of positioning model outputs and the second set of positioning model outputs further based on the set of resources. The set of resources may include at least one of (a) a type of the set of positioning signals, (b) a BW of the set of positioning signals, (c) a timing of the set of positioning signals, or (d) an event trigger associated with the calculation of the set of positioning signals. The positioning configuration may include a third indicator of the positioning model and a fourth indicator of the second positioning model. The apparatus 1504 may include means for transmitting a first request for the positioning model based on the third indicator. The apparatus 1504 may include means for transmitting a second request for the second positioning model based on the fourth indicator. The apparatus 1504 may include means for receiving the positioning model after the transmission of the first request. The apparatus 1504 may include means for receiving the second positioning model after the transmission of the second request. The apparatus 1504 may include means for receiving the positioning configuration by receiving an LPP message including the positioning configuration. The LPP message may include at least one of (a) a location provide message that includes the positioning configuration, (b) an assistance data message that includes the positioning configuration, (c) a broadcast LPP message that includes the positioning configuration, or (d) a posSIB LPP message that includes the positioning configuration. The apparatus 1504 may include means for transmitting a request for the positioning configuration before the reception of the positioning configuration. The apparatus 1504 may include means for receiving a third indicator that a network entity has a capability of transmitting the positioning configuration that includes the second indicator for the apparatus 1504 to use the plurality of positioning models. The transmission of the request for the positioning configuration may be in response to the third indicator. The apparatus 1504 may include means for transmitting a capability message including a third indicator that the apparatus 1504 is configured to concurrently calculate a plurality of positioning model outputs based on the plurality of positioning models before the reception of the positioning configuration. The capability message may include a fourth indicator of a plurality of output types. The plurality of output types may include a first output type of at least one of the set of positioning model outputs and a second output type of at least one of the second set of positioning model outputs. The positioning configuration may include a fifth indicator for the apparatus 1504 to report the at least one of the set of positioning model outputs of the first output type and the at least one of the second set of positioning model outputs of the second output type. The plurality of output types may include at least two of (a) an RSTD, (b) an LOS indicator, (c) a multipath timing indicator, (d) a multipath power indicator, (e) a multipath phase indicator, (f) an RSRP, or (g) an AoD. The capability message may include a fourth indicator of a resource constraint associated with the reception of the set of positioning signals. The resource constraint may include at least one of a maximum bandwidth or a maximum number of measurement occasions. The positioning configuration may include a fifth indicator of a resource of the set of positioning signals that conforms to the resource constraint. The capability message may include a fourth indicator of a first set of measurement gaps. The positioning configuration may include a fifth indicator of a second set of measurement gaps associated with at least one of (a) the measurement of the set of positioning signals, (b) the calculation of the set of positioning model outputs and the second set of positioning model outputs, or (c) a transmission of a positioning report including a sixth indicator of at least one of the set of positioning model outputs and a seventh indicator of at least one of the second set of positioning model outputs. At least one of the second set of measurement gaps may be greater than or equal to at least one of the first set of measurement gaps. The apparatus 1504 may include means for receiving a second request for the capability message. The transmission of the capability message may be in response to the reception of the second request. The apparatus 1504 may include means for transmitting the capability message by transmitting an LPP message including the capability message. The LPP message may include a capability exchange message that includes the capability message. The means may be the component 196 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

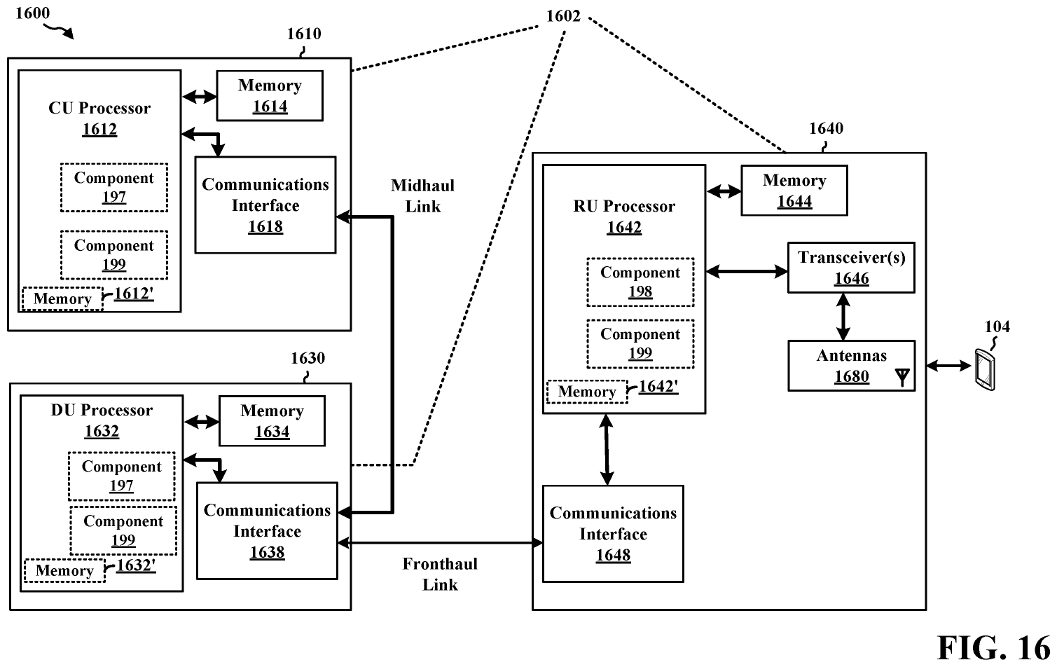

As discussed supra, the component 198 may be configured to receive a positioning configuration. The positioning configuration may include an indicator for the component 198 to use a plurality of positioning models. The component 198 may be configured to receive a set of positioning signals. The component 198 may be configured to measure the set of positioning signals. The component 198 may be configured to calculate a first set of positioning model outputs based on a first positioning model of the plurality of positioning models and the measured set of positioning signals and a second set of positioning model outputs based on a second positioning model of the plurality of positioning models and the measured set of positioning signals. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving a positioning configuration. The positioning configuration may include an indicator for the apparatus 1504 to use a plurality of positioning models. The apparatus 1504 may include means for receiving a set of positioning signals. The apparatus 1504 may include means for measuring the set of positioning signals. The apparatus 1504 may include means for calculating a first set of positioning model outputs based on a first positioning model of the plurality of positioning models and the measured set of positioning signals and calculating a second set of positioning model outputs based on a second positioning model of the plurality of positioning models and the measured set of positioning signals. The apparatus 1504 may include means for transmitting a positioning report. The positioning report may include a second indicator of at least one of the first set of positioning model outputs and a third indicator of at least one of the second set of positioning model outputs. The positioning configuration may include a report configuration for the positioning report. The report configuration may include at least one of: a timing for the transmission of the positioning report, an event trigger associated with the transmission of the positioning report, or a priority indicator for each of a plurality of positioning model outputs. The plurality of positioning model outputs may include the first set of positioning model outputs and the second set of positioning model outputs. The apparatus 1504 may include means for transmitting a first positioning report including a second indicator of at least one of the first set of positioning model outputs. The apparatus 1504 may include means for transmitting a second positioning report including a third indicator of at least one of the second set of positioning model outputs. The apparatus 1504 may include means for obtaining a set of measurement inputs. The apparatus 1504 may include means for obtaining a set of labels. The apparatus 1504 may include means for training the plurality of positioning models based on the set of measurement inputs and the set of labels using AI/ML. At least one of the first set of positioning model outputs may include a first output type. At least one of the second set of positioning model outputs may include a second output type. The first output type and the second output type may be different. A plurality of output types may include the first output type and the second output type. The plurality of output types may include at least two of (a) an RSTD, (b) an LOS indicator, (c) a multipath timing indicator, (d) a multipath power indicator, (e) a multipath phase indicator, (f) an RSRP, or (g) an AoD. The positioning configuration may include a second indicator of the first output type and a third indicator of the second output type. The positioning configuration may include a second indicator of a first set of resources associated with the first positioning model and the measured set of positioning signals and a third indicator of a second set of resources associated with the second positioning model and the measured set of positioning signals. The apparatus 1504 may include means for calculating the first set of positioning model outputs and the second set of positioning model outputs by calculating the first set of positioning model outputs further based on the first set of resources and the second set of positioning model outputs further based on the second set of resources. The first set of resources may include at least one of (a) a type of the set of positioning signals, (b) a BW of the set of positioning signals, (c) a timing of the set of positioning signals, or (d) an event trigger associated with the calculation of the first set of positioning model outputs and the second set of positioning model outputs. The positioning configuration may include a second indicator of a set of resources associated with the first positioning model, the second positioning model, and the measured set of positioning signals. The apparatus 1504 may include means for calculating the first set of positioning model outputs and the second set of positioning model outputs by calculating the first set of positioning model outputs and the second set of positioning model outputs further based on the set of resources. The set of resources may include at least one of (a) a type of the set of positioning signals, (b) a BW of the set of positioning signals, (c) a timing of the set of positioning signals, or (d) an event trigger associated with the calculation of the set of positioning signals. The positioning configuration may include a second indicator of the first positioning model and a third indicator of the second positioning model. The apparatus 1504 may include means for transmitting a first request for the first positioning model based on the second indicator. The apparatus 1504 may include means for transmitting a second request for the second positioning model based on the third indicator. The apparatus 1504 may include means for receiving the first positioning model after the transmission of the first request. The apparatus 1504 may include means for receiving the second positioning model after the transmission of the second request. The apparatus 1504 may include means for receiving the positioning configuration by receiving an LPP message including the positioning configuration. The LPP message may include at least one of (a) a location provide message, (b) an assistance data message, (c) a broadcast LPP message, or (d) a posSIB LPP message. The apparatus 1504 may include means for transmitting a request for the positioning configuration before the reception of the positioning configuration. The apparatus 1504 may include means for receiving a second indicator that a network entity has a capability of transmitting the positioning configuration including the indicator for the apparatus 1504 to use the plurality of positioning models. The transmission may be in response to the second indicator. The apparatus 1504 may include means for transmitting a capability message including a second indicator that the apparatus 1504 is configured to concurrently calculate a plurality of positioning model outputs based on the plurality of positioning models before the reception of the positioning configuration. The capability message may include a third indicator of a plurality of output types. The plurality of output types may include a first output type of at least one of the first set of positioning model outputs and a second output type of at least one of the second set of positioning model outputs. The positioning configuration may include a fifth indicator for the apparatus 1504 to report the at least one of the first set of positioning model outputs of the first output type and the at least one of the second set of positioning model outputs of the second output type. The plurality of output types may include at least two of (a) an RSTD, (b) an LOS indicator, (c) a multipath timing indicator, (d) a multipath power indicator, (e) a multipath phase indicator, (f) an RSRP, or (g) an AoD. The capability message may include a third indicator of a resource constraint associated with the reception of the set of positioning signals. The resource constraint may include at least one of a maximum bandwidth or a maximum number of measurement occasions. The positioning configuration may include a fourth indicator of a resource of the set of positioning signals that conforms to the resource constraint. The capability message may include a third indicator of a first set of measurement gaps. The positioning configuration may include a fourth indicator of a second set of measurement gaps associated with at least one of (a) the measurement of the set of positioning signals, (b) the calculation of the first set of positioning model outputs and the second set of positioning model outputs, or (c) a transmission of a positioning report including a fifth indicator of at least one of the first set of positioning model outputs and a sixth indicator of at least one of the second set of positioning model outputs. At least one of the second set of measurement gaps may be greater than or equal to at least one of the first set of measurement gaps. The apparatus 1504 may include means for receiving a second request for the capability message. The transmission of the capability message may be in response to the reception of the second request. The apparatus 1504 may include means for transmitting the capability message by transmitting an LPP message including the capability message. The LPP message may include a capability exchange message. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means. FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 may be configured to register a set of positioning model IDs and a set of positioning model configurations with a positioning model ID database such that each of the set of positioning model IDs is associated with at least one of the set of positioning model configurations in the positioning model ID database. The component 197 may be configured to transmit a positioning model registration message. The positioning model registration message may include the registered set of positioning model IDs and an indicator of the registered set of positioning model configurations. The component 197 may be within one or more processors of one or more of the CU 1610, DU 1630, and the RU 1640. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for registering a set of positioning model IDs and a set of positioning model configurations with a positioning model ID database such that each of the set of positioning model IDs is associated with at least one of the set of positioning model configurations in the positioning model ID database. The network entity 1602 may include means for transmitting a positioning model registration message including the registered set of positioning model IDs and an indicator of the registered set of positioning model configurations. The network entity 1602 may include means for receiving a request message including a request for the positioning model registration message. The transmission of the positioning model registration message may be in response to the request. The request message may include a set of potential IDs. The network entity 1602 may include means for selecting a first subset of the set of potential IDs from the set of potential IDs for the set of positioning model IDs before the registration of the set of positioning model IDs. The request message may include a set of potential positioning model configurations. The network entity 1602 may include means for configuring the set of positioning model configurations based on the set of potential positioning model configurations. Each of the set of potential positioning model configurations may include at least one of (a) a suggested area for a positioning model, (b) a suggested region for the positioning model, (c) a suggested time period for the positioning model, (d) a suggested duration for the positioning model, or (e) a suggested globality for the positioning model ID database. The request message may include a second indicator of a first number of requested model IDs. The network entity 1602 may include means for configuring a second number of the set of positioning model IDs based on the first number of requested model IDs. The second number may be less than or equal to the first number. The positioning model ID database may include a globality database associated with at least one of (a) a first set of unique model IDs for an entire planet, (b) a second set of unique model IDs for a network, (c) a third set of unique model IDs for an area, or (d) a fourth set of unique model IDs for a UE vendor. The positioning model registration message may include a second indicator of a globality of the positioning model ID database. The network entity 1602 may include means for receiving a positioning model registration failure message including a second indicator of at least one of the set of positioning model IDs that is invalid for registration with a UE. The network entity 1602 may include means for registering a second set of positioning model IDs and the set of positioning model configurations with the positioning model ID database such that each of the second set of positioning model IDs is associated with at least one of the set of positioning model configurations in the positioning model ID database. The second set of positioning model IDs may not include at least one of the set of positioning model IDs that is invalid for registration with the UE. The network entity 1602 may include means for transmitting a second positioning model registration message including the second set of positioning model IDs and a third indicator of the set of positioning model configurations. The network entity 1602 may include means for receiving a request message comprising a request for the second positioning model registration message. The transmission of the second positioning model registration message may be in response to the request. The network entity 1602 may include means for receiving a report message including a second indicator of a selected positioning model ID and a third indicator of a calculated set of positioning model outputs. The set of positioning model IDs may include the selected positioning model ID. The network entity 1602 may include means for transmitting a positioning model registration failure message including a fourth indicator that the selected positioning model ID is invalid for registration. The network entity 1602 may include means for transmitting a second positioning model registration message including a second set of positioning model IDs and a second fifth of the set of positioning model configurations. Each of the second set of positioning model IDs may be associated with at least one of the set of positioning model configurations. The second set of positioning model IDs may not include the selected positioning model ID. The network entity 1602 may include means for receiving a request message including a request for the second positioning model registration message. The transmission of the second positioning model registration message may be in response to the request. The network entity 1602 may include means for transmitting a positioning configuration including a second indicator of a plurality of positioning model IDs. The set of positioning model IDs may include the plurality of positioning model IDs. The network entity 1602 may include means for receiving a positioning report including a third indicator of a set of positioning model outputs based on the positioning configuration. The network entity may include an LMF. The means may be the component 197 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 199 may be configured to configure/calculate a positioning configuration. The positioning configuration may include an indicator for a UE, such as the UE 104, to use a plurality of positioning models on a set of positioning signals. The component 199 may be configured to transmit the positioning configuration. The positioning configuration may include an indicator for the set of positioning signals to be transmitted by a set of wireless devices and/or received by a UE, such as the UE 104. The component 199 may be configured to configure a positioning configuration. The positioning configuration may include an indicator for a UE, such as the UE 104, to use a plurality of positioning models on a set of positioning signals to calculate a plurality of sets of positioning model outputs. The component 199 may be configured to transmit the positioning configuration. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for configuring a positioning configuration. The positioning configuration may include an indicator for a UE, such as the UE 104, to use a plurality of positioning models on a set of positioning signals to calculate a plurality of sets of positioning model outputs. The network entity 1602 may include means for transmitting the positioning configuration. The positioning configuration may include a second indicator for the set of positioning signals to be transmitted by a set of TRPs. The set of TRPs may be identified by an indicator of the positioning configuration. The positioning configuration may include a second indicator for the set of positioning signals to be received by the UE. The set of positioning signals may be identified by an indicator of the positioning configuration. The network entity 1602 may include means for receiving a positioning report including sets of indicators for the plurality of sets of positioning model outputs. Each of the plurality of sets of positioning model outputs may be associated with at least one of the plurality of positioning models. The network entity 1602 may include means for configuring the positioning configuration by configuring a report configuration for the positioning report. The report configuration may include at least one of (a) a timing for a transmission of the positioning report, (b) an event trigger associated with the transmission of the positioning report, or (c) a priority indicator for each set of the plurality of sets of positioning model outputs. The network entity 1602 may include means for receiving a first positioning report including a second indicator of a first set of positioning model outputs associated with a first positioning model of the plurality of positioning models. The network entity 1602 may include means for receiving a second positioning report including a third indicator of a second set of positioning model outputs associated with a second positioning model of the plurality of positioning models. The plurality of sets of positioning model outputs may include the first set of positioning model outputs and the second set of positioning model outputs. The plurality of positioning models may include a first positioning model configured to calculate a first set of positioning model outputs having a first output type and may include a second positioning model configured to calculate a second set of positioning model outputs having a second output type. The first output type and the second output type may be different. The plurality of sets of positioning model outputs may include the first set of positioning model outputs and the second set of positioning model outputs. A plurality of output types may include the first output type and the second output type. The plurality of output types comprise at least two of (a) an RSTD, (b) an LOS indicator, (c) a multipath timing indicator, (d) a multipath power indicator, (e) a multipath phase indicator, (f) an RSRP, or (g) an AoD. The positioning configuration may include a second indicator of the first output type and a third indicator of the second output type. The plurality of positioning models may include a first positioning model and a second positioning model. The positioning configuration may include a second indicator of a first set of resources associated with the first positioning model and a third indicator of a second set of resources associated with the second positioning model. The first set of resources may include at least one of (a) a type of the set of positioning signals, (b) a BW of the set of positioning signals, (c) a timing of the set of positioning signals, or (d) an event trigger associated with a calculation of the plurality of positioning model outputs. The plurality of positioning models may include a first positioning model and a second positioning model. The positioning configuration may include a second indicator of a set of resources associated with the first positioning model, the second positioning model, and the set of positioning signals. The set of resources may include at least one of (a) a type of the set of positioning signals, (b) a BW of the set of positioning signals, (c) a timing of the set of positioning signals, or (d) an event trigger associated with a measurement of the set of positioning signals. The plurality of positioning models may include a first positioning model and a second positioning model. The positioning configuration may include a second indicator of the first positioning model and a third indicator of the second positioning model. The network entity 1602 may include means for receiving a first request for the first positioning model based on the second indicator. The network entity 1602 may include means for receiving a second request for the second positioning model based on the third indicator. The network entity 1602 may include means for transmitting a third indicator the first positioning model in response to the first request. The network entity 1602 may include means for transmitting a fourth indicator of the second positioning model in response to the second request. The network entity 1602 may include means for transmitting the positioning configuration by transmitting an LPP message including the positioning configuration. The LPP message may include at least one of, (a) a location provide message, (b) an assistance data message, (c) a broadcast LPP message, or (d) a posSIB LPP message. The network entity 1602 may include means for receiving a request for the positioning configuration before the reception of the positioning configuration. The network entity 1602 may include means for transmitting a second indicator that the network entity has a capability of transmitting the positioning configuration comprising the indicator for the UE to use the plurality of positioning models before the reception of the request. The network entity 1602 may include means for receiving a capability message including a second indicator that the UE is configured to concurrently calculate the plurality of sets of positioning model outputs based on the plurality of positioning models. The transmission of the positioning configuration may be in response to the second indicator. The capability message may include a third indicator of a plurality of output types. The plurality of output types may be associated with the plurality of sets of positioning model outputs. The positioning configuration may include a fifth indicator for the UE to report each of the plurality of output types. The plurality of output types may include at least two of (a) an RSTD, (b) an LOS indicator, (c) a multipath timing indicator, (d) a multipath power indicator, (e) a multipath phase indicator, (f) an RSRP, or (g) an AoD. The capability message may include a third indicator of a resource constraint associated with the UE receiving the set of positioning signals. The resource constraint may include at least one of a maximum bandwidth or a maximum number of measurement occasions. The positioning configuration may include a fourth indicator of a resource of the set of positioning signals that conforms to the resource constraint. The capability message may include a third indicator of a first set of measurement gaps. The positioning configuration may include a fourth indicator of a second set of measurement gaps associated with at least one of a measurement of the set of positioning signals, a calculation of the plurality of sets of positioning model outputs, or a transmission of a positioning report including a fifth indicator of the plurality of sets of positioning model outputs. At least one of the second set of measurement gaps may be greater than or equal to at least one of the first set of measurement gaps. The network entity 1602 may include means for transmitting a second request for the capability message before the reception of the capability message. The network entity 1602 may include means for receiving the capability message by receiving an LPP message including the capability message. The LPP message may include a capability exchange message. The network entity 1602 may include an LMF or a set of location servers. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

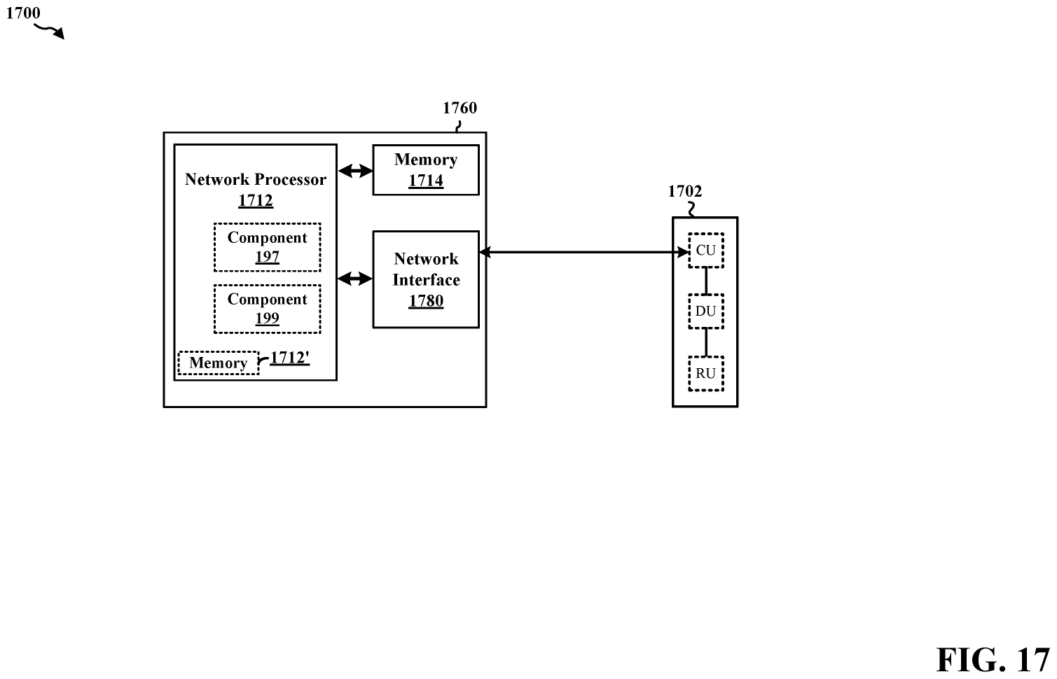

FIG. 17 is a diagram 1700 illustrating an example of a hardware implementation for a network entity 1760. In one example, the network entity 1760 may be within the core network 120. The network entity 1760 may include at least one network processor 1712. The network processor(s) 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The network processor(s) 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 may be configured to register a set of positioning model IDs and a set of positioning model configurations with a positioning model ID database such that each of the set of positioning model IDs is associated with at least one of the set of positioning model configurations in the positioning model ID database. The component 197 may be configured to transmit a positioning model registration message. The positioning model registration message may include the registered set of positioning model IDs and an indicator of the registered set of positioning model configurations. The component 197 may be within the network processor(s) 1712. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1760 may include a variety of components configured for various functions. In one configuration, the network entity 1760 may include means for registering a set of positioning model IDs and a set of positioning model configurations with a positioning model ID database such that each of the set of positioning model IDs is associated with at least one of the set of positioning model configurations in the positioning model ID database. The network entity 1760 may include means for transmitting a positioning model registration message including the registered set of positioning model IDs and an indicator of the registered set of positioning model configurations. The network entity 1760 may include means for receiving a request message including a request for the positioning model registration message. The transmission of the positioning model registration message may be in response to the request. The request message may include a set of potential IDs. The network entity 1760 may include means for selecting a first subset of the set of potential IDs from the set of potential IDs for the set of positioning model IDs before the registration of the set of positioning model IDs. The request message may include a set of potential positioning model configurations. The network entity 1760 may include means for configuring the set of positioning model configurations based on the set of potential positioning model configurations. Each of the set of potential positioning model configurations may include at least one of (a) a suggested area for a positioning model, (b) a suggested region for the positioning model, (c) a suggested time period for the positioning model, (d) a suggested duration for the positioning model, or (e) a suggested globality for the positioning model ID database. The request message may include a second indicator of a first number of requested model IDs. The network entity 1760 may include means for configuring a second number of the set of positioning model IDs based on the first number of requested model IDs. The second number may be less than or equal to the first number. The positioning model ID database may include a globality database associated with at least one of (a) a first set of unique model IDs for an entire planet, (b) a second set of unique model IDs for a network, (c) a third set of unique model IDs for an area, or (d) a fourth set of unique model IDs for a UE vendor. The positioning model registration message may include a second indicator of a globality of the positioning model ID database. The network entity 1760 may include means for receiving a positioning model registration failure message including a second indicator of at least one of the set of positioning model IDs that is invalid for registration with a UE. The network entity 1760 may include means for registering a second set of positioning model IDs and the set of positioning model configurations with the positioning model ID database such that each of the second set of positioning model IDs is associated with at least one of the set of positioning model configurations in the positioning model ID database. The second set of positioning model IDs may not include at least one of the set of positioning model IDs that is invalid for registration with the UE. The network entity 1760 may include means for transmitting a second positioning model registration message including the second set of positioning model IDs and a third indicator of the set of positioning model configurations. The network entity 1760 may include means for receiving a request message comprising a request for the second positioning model registration message. The transmission of the second positioning model registration message may be in response to the request. The network entity 1760 may include means for receiving a report message including a second indicator of a selected positioning model ID and a third indicator of a calculated set of positioning model outputs. The set of positioning model IDs may include the selected positioning model ID. The network entity 1760 may include means for transmitting a positioning model registration failure message including a fourth indicator that the selected positioning model ID is invalid for registration. The network entity 1760 may include means for transmitting a second positioning model registration message including a second set of positioning model IDs and a second fifth of the set of positioning model configurations. Each of the second set of positioning model IDs may be associated with at least one of the set of positioning model configurations. The second set of positioning model IDs may not include the selected positioning model ID. The network entity 1760 may include means for receiving a request message including a request for the second positioning model registration message. The transmission of the second positioning model registration message may be in response to the request. The network entity 1760 may include means for transmitting a positioning configuration including a second indicator of a plurality of positioning model IDs. The set of positioning model IDs may include the plurality of positioning model IDs. The network entity 1760 may include means for receiving a positioning report including a third indicator of a set of positioning model outputs based on the positioning configuration. The network entity may include an LMF. The means may be the component 197 of the network entity 1760 configured to perform the functions recited by the means.

As discussed supra, the component 199 may be configured to configure/calculate a positioning configuration. The positioning configuration may include an indicator for a UE, such as the UE 104 in FIG. 1, to use a plurality of positioning models on a set of positioning signals. The component 199 may be configured to transmit the positioning configuration. The positioning configuration may include an indicator for the set of positioning signals to be transmitted by a set of wireless devices and/or received by a UE, such as the UE 104 in FIG. 1. The component 199 may be configured to configure a positioning configuration. The positioning configuration may include an indicator for a UE, such as the UE 104, to use a plurality of positioning models on a set of positioning signals to calculate a plurality of sets of positioning model outputs. The component 199 may be configured to transmit the positioning configuration. The component 199 may be within the network processor(s) 1712. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1760 may include a variety of components configured for various functions. In one configuration, the network entity 1760 may include means for configuring a positioning configuration. The positioning configuration may include an indicator for a UE, such as the UE 104, to use a plurality of positioning models on a set of positioning signals to calculate a plurality of sets of positioning model outputs. The network entity 1760 may include means for transmitting the positioning configuration. The positioning configuration may include a second indicator for the set of positioning signals to be transmitted by a set of TRPs. The set of TRPs may be identified by an indicator of the positioning configuration. The positioning configuration may include a second indicator for the set of positioning signals to be received by the UE. The set of positioning signals may be identified by an indicator of the positioning configuration. The network entity 1760 may include means for receiving a positioning report including sets of indicators for the plurality of sets of positioning model outputs. Each of the plurality of sets of positioning model outputs may be associated with at least one of the plurality of positioning models. The network entity 1760 may include means for configuring the positioning configuration by configuring a report configuration for the positioning report. The report configuration may include at least one of (a) a timing for a transmission of the positioning report, (b) an event trigger associated with the transmission of the positioning report, or (c) a priority indicator for each set of the plurality of sets of positioning model outputs. The network entity 1760 may include means for receiving a first positioning report including a second indicator of a first set of positioning model outputs associated with a first positioning model of the plurality of positioning models. The network entity 1760 may include means for receiving a second positioning report including a third indicator of a second set of positioning model outputs associated with a second positioning model of the plurality of positioning models. The plurality of sets of positioning model outputs may include the first set of positioning model outputs and the second set of positioning model outputs. The plurality of positioning models may include a first positioning model configured to calculate a first set of positioning model outputs having a first output type and may include a second positioning model configured to calculate a second set of positioning model outputs having a second output type. The first output type and the second output type may be different. The plurality of sets of positioning model outputs may include the first set of positioning model outputs and the second set of positioning model outputs. A plurality of output types may include the first output type and the second output type. The plurality of output types comprise at least two of (a) an RSTD, (b) an LOS indicator, (c) a multipath timing indicator, (d) a multipath power indicator, (e) a multipath phase indicator, (f) an RSRP, or (g) an AoD. The positioning configuration may include a second indicator of the first output type and a third indicator of the second output type. The plurality of positioning models may include a first positioning model and a second positioning model. The positioning configuration may include a second indicator of a first set of resources associated with the first positioning model and a third indicator of a second set of resources associated with the second positioning model. The first set of resources may include at least one of (a) a type of the set of positioning signals, (b) a BW of the set of positioning signals, (c) a timing of the set of positioning signals, or (d) an event trigger associated with a calculation of the plurality of positioning model outputs. The plurality of positioning models may include a first positioning model and a second positioning model. The positioning configuration may include a second indicator of a set of resources associated with the first positioning model, the second positioning model, and the set of positioning signals. The set of resources may include at least one of (a) a type of the set of positioning signals, (b) a BW of the set of positioning signals, (c) a timing of the set of positioning signals, or (d) an event trigger associated with a measurement of the set of positioning signals. The plurality of positioning models may include a first positioning model and a second positioning model. The positioning configuration may include a second indicator of the first positioning model and a third indicator of the second positioning model. The network entity 1760 may include means for receiving a first request for the first positioning model based on the second indicator. The network entity 1760 may include means for receiving a second request for the second positioning model based on the third indicator. The network entity 1760 may include means for transmitting a third indicator the first positioning model in response to the first request. The network entity 1760 may include means for transmitting a fourth indicator of the second positioning model in response to the second request. The network entity 1760 may include means for transmitting the positioning configuration by transmitting an LPP message including the positioning configuration. The LPP message may include at least one of, (a) a location provide message, (b) an assistance data message, (c) a broadcast LPP message, or (d) a posSIB LPP message. The network entity 1760 may include means for receiving a request for the positioning configuration before the reception of the positioning configuration. The network entity 1760 may include means for transmitting a second indicator that the network entity has a capability of transmitting the positioning configuration comprising the indicator for the UE to use the plurality of positioning models before the reception of the request. The network entity 1760 may include means for receiving a capability message including a second indicator that the UE is configured to concurrently calculate the plurality of sets of positioning model outputs based on the plurality of positioning models. The transmission of the positioning configuration may be in response to the second indicator. The capability message may include a third indicator of a plurality of output types. The plurality of output types may be associated with the plurality of sets of positioning model outputs. The positioning configuration may include a fifth indicator for the UE to report each of the plurality of output types. The plurality of output types may include at least two of (a) an RSTD, (b) an LOS indicator, (c) a multipath timing indicator, (d) a multipath power indicator, (e) a multipath phase indicator, (f) an RSRP, or (g) an AoD. The capability message may include a third indicator of a resource constraint associated with the UE receiving the set of positioning signals. The resource constraint may include at least one of a maximum bandwidth or a maximum number of measurement occasions. The positioning configuration may include a fourth indicator of a resource of the set of positioning signals that conforms to the resource constraint. The capability message may include a third indicator of a first set of measurement gaps. The positioning configuration may include a fourth indicator of a second set of measurement gaps associated with at least one of a measurement of the set of positioning signals, a calculation of the plurality of sets of positioning model outputs, or a transmission of a positioning report including a fifth indicator of the plurality of sets of positioning model outputs. At least one of the second set of measurement gaps may be greater than or equal to at least one of the first set of measurement gaps. The network entity 1760 may include means for transmitting a second request for the capability message before the reception of the capability message. The network entity 1760 may include means for receiving the capability message by receiving an LPP message including the capability message. The LPP message may include a capability exchange message. The network entity 1760 may include an LMF or a set of location servers. The means may be the component 199 of the network entity 1760 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without using a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a component of the device that transmits the data. A device configured to “obtain” data, such as a transmission, signal, or message, may receive, for example with a transceiver, or may obtain the data from a component of the device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving a positioning model registration message comprising a set of positioning model IDs and an indicator of a set of positioning model configurations, wherein each of the set of positioning model IDs is associated with at least one of the set of positioning model configurations; receiving a set of positioning signals; measuring the set of positioning signals; selecting a positioning model ID from the set of positioning model IDs based on the set of positioning model configurations and an environmental attribute of the UE; and calculating a set of positioning model outputs based on the measured set of positioning signals and a positioning model associated with the selected positioning model ID.

Aspect 2 is the method of aspect 1, further comprising transmitting a request message comprising a request for the positioning model registration message before the reception of the positioning model registration message.

Aspect 3 is the method of aspect 2, wherein the request message further comprises a set of potential IDs, wherein a first subset of the set of positioning model IDs comprises a second subset of the set of potential IDs.

Aspect 4 is the method of either of aspects 2 or 3, wherein the request message further comprises a set of potential positioning model configurations, wherein a first subset of the set of positioning model configurations comprises a second subset of the set of potential positioning model configurations, wherein each of the set of potential positioning model configurations comprises at least one of: a suggested area for a suggested positioning model; a suggested time period for the suggested positioning model; a suggested duration for the suggested positioning model; or a suggested globality database for the suggested positioning model.

Aspect 5 is the method of any of aspects 2 to 4, wherein the request message further comprises a second indicator of a number of requested model IDs, wherein the set of positioning model IDs comprises the number of requested model IDs.

Aspect 6 is the method of any of aspects 1 to 5, wherein the positioning model registration message comprises a second indicator of a globality database associated with the set of positioning model IDs and the set of positioning model configurations, wherein the globality database is associated with at least one of: a first positioning model ID database comprising a first set of unique model IDs for an entire planet; a second positioning model ID database comprising a second set of unique model IDs for a network; a third positioning model ID database comprising a third set of unique model IDs for an area; or a fourth positioning model ID database comprising a fourth set of unique model IDs for a UE vendor.

Aspect 7 is the method of any of aspects 1 to 6, further comprising: transmitting a positioning model registration failure message comprising a second indicator of at least one of the set of positioning model IDs that is invalid for registration with the UE; and receiving a second positioning model registration message comprising a second set of positioning model IDs and a third indicator of the set of positioning model configurations, wherein each of the second set of positioning model IDs is associated with at least one of the set of positioning model configurations, wherein the second set of positioning model IDs does not include at least one of the set of positioning model IDs that is invalid for registration with the UE, wherein the second set of positioning model IDs comprises the selected positioning model ID.

Aspect 8 is the method of aspect 7, further comprising transmitting a request message comprising a request for the second positioning model registration message before the reception of the second positioning model registration message.

Aspect 9 is the method of any of aspects 1 to 8, further comprising transmitting a report message comprising a second indicator of the selected positioning model ID and a third indicator of at least one of the calculated set of positioning model outputs.

Aspect 10 is the method of aspect 9, further comprising: receiving a positioning model registration failure message comprising a fourth indicator that the selected positioning model ID is invalid for registration; and receiving a second positioning model registration message comprising a second set of positioning model IDs, wherein each of the second set of positioning model IDs is associated with at least one of a second set of positioning model configurations, wherein the second set of positioning model IDs does not include the selected positioning model ID.

Aspect 11 is the method of aspect 10, further comprising transmitting a request message comprising a request for the second positioning model registration message before the reception of the second positioning model registration message.

Aspect 12 is the method of any of aspects 1 to 11, wherein the environmental attribute of the UE comprises at least one of: an area associated with a calculated location of the UE; a region associated with the calculated location of the UE; a time period associated with a clock of the UE; or a duration associated with the clock of the UE.

Aspect 13 is the method of any of aspects 1 to 12, comprising: receiving a positioning configuration comprising a second indicator of a plurality of positioning model IDs associated with a plurality of positioning models, wherein the plurality of positioning model IDs comprises the selected positioning model ID and a second positioning model ID, wherein selecting the positioning model ID further comprises selecting the plurality of positioning model IDs from the set of positioning model IDs based on the positioning configuration; and calculating a second set of positioning model outputs based on the measured set of positioning signals and a second positioning model associated with the second positioning model ID.

Aspect 14 is the method of aspect 13, further comprising transmitting a positioning report comprising a third indicator of the set of positioning model outputs and a fourth indicator of the second set of positioning model outputs.

Aspect 15 is the method of aspect 14, wherein the positioning configuration comprises a report configuration for the positioning report, wherein the report configuration comprises at least one of: a timing for the transmission of the positioning report; an event trigger associated with the transmission of the positioning report; or a priority indicator for each of a plurality of positioning model outputs, wherein the plurality of positioning model outputs comprises the set of positioning model outputs and the second set of positioning model outputs.

Aspect 16 is the method of any of aspects 13 to 15, further comprising transmitting a first positioning report comprising a third indicator of at least one of the set of positioning model outputs; and transmitting a second positioning report comprising a fourth indicator of at least one of the second set of positioning model outputs.

Aspect 17 is the method of any of aspects 13 to 16, further comprising: obtaining a set of measurement inputs; obtaining a set of labels; and training the plurality of positioning models based on the set of measurement inputs and the set of labels using artificial intelligence machine learning (AI/ML).

Aspect 18 is the method of any of aspects 13 to 17, wherein at least one of the set of positioning model outputs comprises a first output type and at least one of the second set of positioning model outputs comprises a second output type, wherein the first output type and the second output type are different.

Aspect 19 is the method of aspect 18, wherein a plurality of output types comprises the first output type and the second output type, wherein the plurality of output types comprises at least two of: a reference signal time difference (RSTD); a line of sight (LOS) indicator; a multipath timing indicator; a multipath power indicator; a multipath phase indicator; a reference signal received power (RSRP); or an angle of departure (AoD).

Aspect 20 is the method of aspect 18, wherein the positioning configuration comprises a third indicator of the first output type and a fourth indicator of the second output type.

Aspect 21 is the method of any of aspects 13 to 20, wherein the positioning configuration comprises a third indicator of a first set of resources associated with the positioning model and the measured set of positioning signals and a fourth indicator of a second set of resources associated with the second positioning model and the measured set of positioning signals, wherein calculating the set of positioning model outputs and the second set of positioning model outputs comprises: calculating the set of positioning model outputs further based on the first set of resources; and calculating the second set of positioning model outputs further based on the second set of resources.

Aspect 22 is the method of aspect 21, wherein the first set of resources comprises at least one of: a type of the set of positioning signals; a bandwidth (BW) of the set of positioning signals; a timing of the set of positioning signals; or an event trigger associated with the calculation of the set of positioning model outputs.

Aspect 23 is the method of any of aspects 13 to 22, wherein the positioning configuration comprises a third indicator of a set of resources associated with the positioning model, the second positioning model, and the measured set of positioning signals, wherein calculating the set of positioning model outputs and the second set of positioning model outputs comprises: calculating the set of positioning model outputs and the second set of positioning model outputs further based on the set of resources.

Aspect 24 is the method of aspect 23, wherein the set of resources comprises at least one of: a type of the set of positioning signals; a bandwidth (BW) of the set of positioning signals; a timing of the set of positioning signals; or an event trigger associated with the calculation of the set of positioning signals.

Aspect 25 is the method of any of aspects 13 to 24, wherein the positioning configuration comprises a third indicator of the positioning model and a fourth indicator of the second positioning model, further comprising: transmitting a first request for the positioning model based on the third indicator; transmitting a second request for the second positioning model based on the fourth indicator; receiving the positioning model after the transmission of the first request; and receiving the second positioning model after the transmission of the second request.

Aspect 26 is the method of any of aspects 13 to 25, wherein receiving the positioning configuration comprises: receiving a long term evolution (LTE) positioning protocol (LPP) message comprising the positioning configuration.

Aspect 27 is the method of aspect 26, wherein the LPP message comprises at least one of: a location provide message; an assistance data message; a broadcast LPP message; or a positioning system information block (posSIB) LPP message.

Aspect 28 is the method of any of aspects 13 to 27, further comprising: transmitting a request for the positioning configuration before the reception of the positioning configuration.

Aspect 29 is the method of aspect 28, further comprising: receiving a third indicator that a network entity has a capability of transmitting the positioning configuration comprising the second indicator for the UE to use the plurality of positioning models, wherein the transmission of the request for the positioning configuration is in response to the third indicator.

Aspect 30 is the method of any of aspects 13 to 29, further comprising: transmitting a capability message comprising a third indicator that the UE is configured to concurrently calculate a plurality of positioning model outputs based on the plurality of positioning models before the reception of the positioning configuration.

Aspect 31 is the method of aspect 30, wherein the capability message comprises a fourth indicator of a plurality of output types, wherein the plurality of output types comprises a first output type of at least one of the set of positioning model outputs and a second output type of at least one of the second set of positioning model outputs, wherein the positioning configuration comprises a fifth indicator for the UE to report the at least one of the set of positioning model outputs of the first output type and the at least one of the second set of positioning model outputs of the second output type.

Aspect 32 is the method of aspect 31, wherein the plurality of output types comprises at least two of: a reference signal time difference (RSTD); a line of sight (LOS) indicator; a multipath timing indicator; a multipath power indicator; a multipath phase indicator; a reference signal received power (RSRP); or an angle of departure (AoD).

Aspect 33 is the method of any of aspects 30 to 32, wherein the capability message comprises a fourth indicator of a resource constraint associated with the reception of the set of positioning signals, wherein the resource constraint comprises at least one of a maximum bandwidth or a maximum number of measurement occasions, wherein the positioning configuration comprises a fifth indicator of a resource of the set of positioning signals that conforms to the resource constraint.

Aspect 34 is the method of any of aspects 30 to 33, wherein the capability message comprises a fourth indicator of a first set of measurement gaps, wherein the positioning configuration comprises a fifth indicator of a second set of measurement gaps associated with at least one of the measurement of the set of positioning signals, the calculation of the set of positioning model outputs and the second set of positioning model outputs, or a transmission of a positioning report comprising a sixth indicator of at least one of the set of positioning model outputs and a seventh indicator of at least one of the second set of positioning model outputs, wherein at least one of the second set of measurement gaps is greater than or equal to at least one of the first set of measurement gaps.

Aspect 35 is the method of any of aspects 30 to 34, further comprising receiving a second request for the capability message, wherein the transmission of the capability message is in response to the reception of the second request.

Aspect 36 is the method of any of aspects 30 to 35, wherein transmitting the capability message comprises transmitting a long term evolution (LTE) positioning protocol (LPP) message comprising the capability message.

Aspect 37 is the method of aspect 36, wherein the LPP message comprises a capability exchange message.

Aspect 38 is a method of wireless communication at a network entity, comprising: registering a set of positioning model IDs and a set of positioning model configurations with a positioning model ID database such that each of the set of positioning model IDs is associated with at least one of the set of positioning model configurations in the positioning model ID database; and transmitting a positioning model registration message comprising the registered set of positioning model IDs and an indicator of the registered set of positioning model configurations.

Aspect 39 is the method of aspect 38, further comprising receiving a request message comprising a request for the positioning model registration message, wherein the transmission of the positioning model registration message is in response to the request.

Aspect 40 is the method of aspect 39, wherein the request message further comprises a set of potential IDs, further comprising: selecting a first subset of the set of potential IDs from the set of potential IDs for the set of positioning model IDs before the registration of the set of positioning model IDs.

Aspect 41 is the method of either of aspects 39 or 40, wherein the request message further comprises a set of potential positioning model configurations, further comprising: configuring the set of positioning model configurations based on the set of potential positioning model configurations, wherein each of the set of potential positioning model configurations comprises at least one of: a suggested area for a positioning model; a suggested region for the positioning model; a suggested time period for the positioning model; a suggested duration for the positioning model; or a suggested globality for the positioning model ID database.

Aspect 42 is the method of any of aspects 39 to 41, wherein the request message further comprises a second indicator of a first number of requested model IDs, further comprising: configuring a second number of the set of positioning model IDs based on the first number of requested model IDs, wherein the second number is less than or equal to the first number.

Aspect 43 is the method of any of aspects 38 to 42, wherein the positioning model ID database comprises a globality database associated with at least one of: a first set of unique model IDs for an entire planet; a second set of unique model IDs for a network; a third set of unique model IDs for an area; or a fourth set of unique model IDs for a UE vendor.

Aspect 44 is the method of any of aspects 38 to 43, wherein the positioning model registration message comprises a second indicator of a globality of the positioning model ID database.

Aspect 45 is the method of any of aspects 38 to 44, further comprising: receiving a positioning model registration failure message comprising a second indicator of at least one of the set of positioning model IDs that is invalid for registration with a user equipment (UE); registering a second set of positioning model IDs and the set of positioning model configurations with the positioning model ID database such that each of the second set of positioning model IDs is associated with at least one of the set of positioning model configurations in the positioning model ID database, wherein the second set of positioning model IDs does not include at least one of the set of positioning model IDs that is invalid for registration with the UE; and transmitting a second positioning model registration message comprising the second set of positioning model IDs and a third indicator of the set of positioning model configurations.

Aspect 46 is the method of aspect 45, further comprising receiving a request message comprising a request for the second positioning model registration message, wherein the transmission of the second positioning model registration message is in response to the request.

Aspect 47 is the method of any of aspects 38 to 46, further comprising: receiving a report message comprising a second indicator of a selected positioning model ID and a third indicator of a calculated set of positioning model outputs, wherein the set of positioning model IDs comprises the selected positioning model ID.

Aspect 48 is the method of aspect 47, further comprising: transmitting a positioning model registration failure message comprising a fourth indicator that the selected positioning model ID is invalid for registration; and transmitting a second positioning model registration message comprising a second set of positioning model IDs and a second fifth of the set of positioning model configurations, wherein each of the second set of positioning model IDs is associated with at least one of the set of positioning model configurations, wherein the second set of positioning model IDs does not include the selected positioning model ID.

Aspect 49 is the method of aspect 48, further comprising: receiving a request message comprising a request for the second positioning model registration message, wherein the transmission of the second positioning model registration message is in response to the request.

Aspect 50 is the method of any of aspects 38 to 49, comprising: transmitting a positioning configuration comprising a second indicator of a plurality of positioning model IDs, wherein the set of positioning model IDs comprise the plurality of positioning model IDs; and receiving a positioning report comprising a third indicator of a set of positioning model outputs based on the positioning configuration.

Aspect 51 is the method of any of aspects 38 to 50, wherein the network entity comprises a location management function (LMF).

Aspect 52 is a method of wireless communication at a user equipment (UE) comprising: receiving a positioning configuration comprising an indicator for the UE to use a plurality of positioning models; receiving a set of positioning signals; measuring the set of positioning signals; and calculating a first set of positioning model outputs based on a first positioning model of the plurality of positioning models and the measured set of positioning signals and a second set of positioning model outputs based on a second positioning model of the plurality of positioning models and the measured set of positioning signals.

Aspect 53 is the method of aspect 52, further comprising: transmitting a positioning report comprising a second indicator of at least one of the first set of positioning model outputs and a third indicator of at least one of the second set of positioning model outputs.

Aspect 54 is the method of aspect 53, wherein the positioning configuration comprises a report configuration for the positioning report, wherein the report configuration comprises at least one of: a timing for the transmission of the positioning report; an event trigger associated with the transmission of the positioning report; or a priority indicator for each of a plurality of positioning model outputs, wherein the plurality of positioning model outputs comprises the first set of positioning model outputs and the second set of positioning model outputs.

Aspect 55 is the method of any of aspects 52 to 56, further comprising: transmitting a first positioning report comprising a second indicator of at least one of the first set of positioning model outputs; and transmitting a second positioning report comprising a third indicator of at least one of the second set of positioning model outputs.

Aspect 56 is the method of any of aspects 52 to 55, further comprising: obtaining a set of measurement inputs; obtaining a set of labels; and training the plurality of positioning models based on the set of measurement inputs and the set of labels using artificial intelligence machine learning (AI/ML).

Aspect 57 is the method of any of aspects 52 to 56, wherein at least one of the first set of positioning model outputs comprises a first output type and at least one of the second set of positioning model outputs comprises a second output type, wherein the first output type and the second output type are different.

Aspect 58 is the method of aspect 57, wherein a plurality of output types comprises the first output type and the second output type, wherein the plurality of output types comprises at least two of: a reference signal time difference (RSTD); a line of sight (LOS) indicator; a multipath timing indicator; a multipath power indicator; a multipath phase indicator; a reference signal received power (RSRP); or an angle of departure (AoD).

Aspect 59 is the method of either of aspects 57 or 58, wherein the positioning configuration comprises a second indicator of the first output type and a third indicator of the second output type.

Aspect 60 is the method of any of aspects 52 to 59, wherein the positioning configuration comprises a second indicator of a first set of resources associated with the first positioning model and the measured set of positioning signals and a third indicator of a second set of resources associated with the second positioning model and the measured set of positioning signals, wherein calculating the first set of positioning model outputs and the second set of positioning model outputs comprises: calculating the first set of positioning model outputs further based on the first set of resources and the second set of positioning model outputs further based on the second set of resources.

Aspect 61 is the method of aspect 60, wherein the first set of resources comprises at least one of: a type of the set of positioning signals; a bandwidth (BW) of the set of positioning signals; a timing of the set of positioning signals; or an event trigger associated with the calculation of the first set of positioning model outputs and the second set of positioning model outputs.

Aspect 62 is the method of any of aspects 52 to 61, wherein the positioning configuration comprises a second indicator of a set of resources associated with the first positioning model, the second positioning model, and the measured set of positioning signals, wherein calculating the first set of positioning model outputs and the second set of positioning model outputs comprises: calculating the first set of positioning model outputs and the second set of positioning model outputs further based on the set of resources.

Aspect 63 is the method of aspect 62, wherein the set of resources comprises at least one of: a type of the set of positioning signals; a bandwidth (BW) of the set of positioning signals; a timing of the set of positioning signals; or an event trigger associated with the calculation of the set of positioning signals.

Aspect 64 is the method of any of aspects 52 to 63, wherein the positioning configuration comprises a second indicator of the first positioning model and a third indicator of the second positioning model, further comprising: transmitting a first request for the first positioning model based on the second indicator; transmitting a second request for the second positioning model based on the third indicator; receiving the first positioning model after the transmission of the first request; and receiving the second positioning model after the transmission of the second request.

Aspect 65 is the method of any of aspects 52 to 64, wherein receiving the positioning configuration comprises receiving a long term evolution (LTE) positioning protocol (LPP) message comprising the positioning configuration.

Aspect 66 is the method of aspect 65, wherein the LPP message comprises at least one of: a location provide message; an assistance data message; a broadcast LPP message; or a positioning system information block (posSIB) LPP message.

Aspect 67 is the method of any of aspects 52 to 66, further comprising transmitting a request for the positioning configuration before the reception of the positioning configuration.

Aspect 68 is the method of aspect 67, further comprising: receiving a second indicator that a network entity has a capability of transmitting the positioning configuration comprising the indicator for the UE to use the plurality of positioning models, wherein the transmission is in response to the second indicator.

Aspect 69 is the method of any of aspects 52 to 68, further comprising transmitting a capability message comprising a second indicator that the UE is configured to concurrently calculate a plurality of positioning model outputs based on the plurality of positioning models before the reception of the positioning configuration.

Aspect 70 is the method of aspect 69, wherein the capability message comprises a third indicator of a plurality of output types, wherein the plurality of output types comprises a first output type of at least one of the first set of positioning model outputs and a second output type of at least one of the second set of positioning model outputs, wherein the positioning configuration comprises a fifth indicator for the UE to report the at least one of the first set of positioning model outputs of the first output type and the at least one of the second set of positioning model outputs of the second output type.

Aspect 71 is the method of aspect 70, wherein the plurality of output types comprises at least two of: a reference signal time difference (RSTD); a line of sight (LOS) indicator; a multipath timing indicator; a multipath power indicator; a multipath phase indicator; a reference signal received power (RSRP); or an angle of departure (AoD).

Aspect 72 is the method of any of aspects 69 to 71, wherein the capability message comprises a third indicator of a resource constraint associated with the reception of the set of positioning signals, wherein the resource constraint comprises at least one of a maximum bandwidth or a maximum number of measurement occasions, wherein the positioning configuration comprises a fourth indicator of a resource of the set of positioning signals that conforms to the resource constraint.

Aspect 73 is the method of any of aspects 69 to 72, wherein the capability message comprises a third indicator of a first set of measurement gaps, wherein the positioning configuration comprises a fourth indicator of a second set of measurement gaps associated with at least one of the measurement of the set of positioning signals, the calculation of the first set of positioning model outputs and the second set of positioning model outputs, or a transmission of a positioning report comprising a fifth indicator of at least one of the first set of positioning model outputs and a sixth indicator of at least one of the second set of positioning model outputs, wherein at least one of the second set of measurement gaps is greater than or equal to at least one of the first set of measurement gaps.

Aspect 74 is the method of any of aspects 69 to 73, further comprising receiving a second request for the capability message, wherein the transmission of the capability message is in response to the reception of the second request.

Aspect 75 is the method of any of aspects 69 to 74, wherein transmitting the capability message comprises: transmitting a long term evolution (LTE) positioning protocol (LPP) message comprising the capability message.

Aspect 76 is the method of aspect 75, wherein the LPP message comprises a capability exchange message.

Aspect 77 is a method of wireless communication at a network entity comprising: configuring a positioning configuration comprising an indicator for a user equipment (UE) to use a plurality of positioning models on a set of positioning signals to calculate a plurality of sets of positioning model outputs; and transmitting the positioning configuration.

Aspect 78 is a method of aspect 77, wherein the positioning configuration further comprises a second indicator for the set of positioning signals to be transmitted by a set of transmission reception points (TRPs).

Aspect 79 is a method of either of aspects 77 or 78, wherein the positioning configuration further comprises a second indicator for the set of positioning signals to be received by the UE.

Aspect 80 is a method of any of aspects 77 to 79, further comprising: receiving a positioning report comprising sets of indicators for the plurality of sets of positioning model outputs, wherein each of the plurality of sets of positioning model outputs is associated with at least one of the plurality of positioning models.

Aspect 81 is a method of aspect 80, wherein configuring the positioning configuration further comprises configuring a report configuration for the positioning report, wherein the report configuration comprises at least one of: a timing for a transmission of the positioning report; an event trigger associated with the transmission of the positioning report; or a priority indicator for each set of the plurality of sets of positioning model outputs.

Aspect 82 is a method of any of aspects 77 to 81, further comprising: receiving a first positioning report comprising a second indicator of a first set of positioning model outputs associated with a first positioning model of the plurality of positioning models; and receiving a second positioning report comprising a third indicator of a second set of positioning model outputs associated with a second positioning model of the plurality of positioning models, wherein the plurality of sets of positioning model outputs comprise the first set of positioning model outputs and the second set of positioning model outputs.

Aspect 83 is a method of any of aspects 77 to 82, wherein the plurality of positioning models comprise a first positioning model configured to calculate a first set of positioning model outputs having a first output type and a second positioning model configured to calculate a second set of positioning model outputs having a second output type, wherein the first output type and the second output type are different, wherein the plurality of sets of positioning model outputs comprise the first set of positioning model outputs and the second set of positioning model outputs.

Aspect 84 is a method of aspect 83, wherein a plurality of output types comprise the first output type and the second output type, wherein the plurality of output types comprise at least two of: a reference signal time difference (RSTD); a line of sight (LOS) indicator; a multipath timing indicator; a multipath power indicator; a multipath phase indicator; a reference signal received power (RSRP); or an angle of departure (AoD).

Aspect 85 is a method of either of aspects 83 or 84, wherein the positioning configuration comprises a second indicator of the first output type and a third indicator of the second output type.

Aspect 86 is a method of any of aspects 77 to 85, wherein the plurality of positioning models comprise a first positioning model and a second positioning model, wherein the positioning configuration comprises a second indicator of a first set of resources associated with the first positioning model and a third indicator of a second set of resources associated with the second positioning model.

Aspect 87 is a method of aspect 86, wherein the first set of resources comprises at least one of: a type of the set of positioning signals; a bandwidth (BW) of the set of positioning signals; a timing of the set of positioning signals; or an event trigger associated with a calculation of the plurality of positioning model outputs.

Aspect 88 is a method of any of aspects 77 to 87, wherein the plurality of positioning models comprise a first positioning model and a second positioning model, wherein the positioning configuration comprises a second indicator of a set of resources associated with the first positioning model, the second positioning model, and the set of positioning signals.

Aspect 89 is a method of aspect 88, wherein the set of resources comprises at least one of: a type of the set of positioning signals; a bandwidth (BW) of the set of positioning signals; a timing of the set of positioning signals; or an event trigger associated with a measurement of the set of positioning signals.

Aspect 90 is a method of any of aspects 77 to 89, wherein the plurality of positioning models comprise a first positioning model and a second positioning model, wherein the positioning configuration comprises a second indicator of the first positioning model and a third indicator of the second positioning model, further comprising: receiving a first request for the first positioning model based on the second indicator; receiving a second request for the second positioning model based on the third indicator; transmitting a third indicator the first positioning model in response to the first request; and transmitting a fourth indicator of the second positioning model in response to the second request.

Aspect 91 is a method of any of aspects 77 to 90, wherein transmitting the positioning configuration comprises transmitting a long term evolution (LTE) positioning protocol (LPP) message comprising the positioning configuration.

Aspect 92 is a method of aspect 91, wherein the LPP message comprises at least one of: a location provide message; an assistance data message; a broadcast LPP message; or a positioning system information block (posSIB) LPP message.

Aspect 93 is a method of any of aspects 77 to 92, further comprising receiving a request for the positioning configuration before the reception of the positioning configuration.

Aspect 94 is a method of aspect 93, further comprising transmitting a second indicator that the network entity has a capability of transmitting the positioning configuration comprising the indicator for the UE to use the plurality of positioning models before the reception of the request.

Aspect 95 is a method of any of aspects 77 to 94, further comprising: receiving a capability message comprising a second indicator that the UE is configured to concurrently calculate the plurality of sets of positioning model outputs based on the plurality of positioning models, wherein the transmission of the positioning configuration is in response to the second indicator.

Aspect 96 is a method of aspect 95, wherein the capability message comprises a third indicator of a plurality of output types, wherein the plurality of output types is associated with the plurality of sets of positioning model outputs, wherein the positioning configuration comprises a fifth indicator for the UE to report each of the plurality of output types.

Aspect 97 is a method of aspect 96, wherein the plurality of output types comprise at least two of: a reference signal time difference (RSTD); a line of sight (LOS) indicator; a multipath timing indicator; a multipath power indicator; a multipath phase indicator; a reference signal received power (RSRP); or an angle of departure (AoD).

Aspect 98 is a method of any of aspects 95 to 97, wherein the capability message comprises a third indicator of a resource constraint associated with the UE receiving the set of positioning signals, wherein the resource constraint comprises at least one of a maximum bandwidth or a maximum number of measurement occasions, wherein the positioning configuration comprises a fourth indicator of a resource of the set of positioning signals that conforms to the resource constraint.

Aspect 99 is a method of any of aspects 95 to 98, wherein the capability message comprises a third indicator of a first set of measurement gaps, wherein the positioning configuration comprises a fourth indicator of a second set of measurement gaps associated with at least one of a measurement of the set of positioning signals, a calculation of the plurality of sets of positioning model outputs, or a transmission of a positioning report comprising a fifth indicator of the plurality of sets of positioning model outputs, wherein at least one of the second set of measurement gaps is greater than or equal to at least one of the first set of measurement gaps.

Aspect 100 is a method of any of aspects 95 to 99, further comprising transmitting a second request for the capability message before the reception of the capability message.

Aspect 101 is a method of any of aspects 95 to 100, wherein receiving the capability message comprises: receiving a long term evolution (LTE) positioning protocol (LPP) message comprising the capability message.

Aspect 102 is a method of aspect 101, wherein the LPP message comprises a capability exchange message.

Aspect 103 is a method of any of aspects 77 to 102, wherein the network entity comprises a location management function (LMF).

Aspect 104 is an apparatus for wireless communication, comprising: at least one memory; and at least one processor coupled to the at least one memory and, based at least in part on information stored in the at least one memory, the at least one processor, individually or in any combination, is configured to perform the method of any of aspects 1 to 103.

Aspect 105 is an apparatus for wireless communication, comprising means for performing each step in the method of any of aspects 1 to 103.

Aspect 106 is the apparatus of any of aspects 1 to 103, further comprising at least one of a transceiver or an antenna (e.g., at least one of a transceiver or an antenna coupled to the at least one processor in Aspect 104) configured to receive or to transmit in association with the method of any of aspects 1 to 103.

Aspect 107 is a computer-readable medium (e.g., a non-transitory computer-readable medium) storing computer executable code, the code when executed by at least one processor causes the at least one processor to perform the method of any of aspects 1 to 103.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive a positioning model registration message comprising a set of positioning model IDs and an indicator of a set of positioning model configurations, wherein each of the set of positioning model IDs is associated with at least one of the set of positioning model configurations;
receive a set of positioning signals;
measure the set of positioning signals;
select a positioning model ID from the set of positioning model IDs based on the set of positioning model configurations and an environmental attribute of the UE; and
calculate a set of positioning model outputs based on the measured set of positioning signals and a positioning model associated with the selected positioning model ID.

2. The apparatus of claim 1, wherein the at least one processor, individually or in any combination, is further configured to:
transmit a request message comprising a request for the positioning model registration message before the reception of the positioning model registration message.

3. The apparatus of claim 2, wherein the request message further comprises a set of potential IDs, wherein a first subset of the set of positioning model IDs comprises a second subset of the set of potential IDs.

4. The apparatus of claim 2, wherein the request message further comprises a second indicator of a number of requested model IDs, wherein the set of positioning model IDs comprises the number of requested model IDs.

5. The apparatus of claim 1, wherein the at least one processor, individually or in any combination, is further configured to:
transmit a positioning model registration failure message comprising a second indicator of at least one of the set of positioning model IDs that is invalid for registration with the UE; and
receive a second positioning model registration message comprising a second set of positioning model IDs and a third indicator of the set of positioning model configurations, wherein each of the second set of positioning model IDs is associated with at least one of the set of positioning model configurations, wherein the second set of positioning model IDs does not include at least one of the set of positioning model IDs that is invalid for registration with the UE, wherein the second set of positioning model IDs comprises the selected positioning model ID.

6. The apparatus of claim 5, wherein the at least one processor, individually or in any combination, is further configured to:
transmit a request message comprising a request for the second positioning model registration message before the reception of the second positioning model registration message.

7. The apparatus of claim 1, wherein the at least one processor, individually or in any combination, is further configured to:
transmit a report message comprising a second indicator of the selected positioning model ID and a third indicator of at least one of the calculated set of positioning model outputs.

8. The apparatus of claim 7, wherein the at least one processor, individually or in any combination, is further configured to:
receive a positioning model registration failure message comprising a fourth indicator that the selected positioning model ID is invalid for registration; and
receive a second positioning model registration message comprising a second set of positioning model IDs, wherein each of the second set of positioning model IDs is associated with at least one of a second set of positioning model configurations, wherein the second set of positioning model IDs does not include the selected positioning model ID.

9. The apparatus of claim 8, wherein the at least one processor, individually or in any combination, is further configured to:
transmit a request message comprising a request for the second positioning model registration message before the reception of the second positioning model registration message.

10. The apparatus of claim 1, wherein the environmental attribute of the UE comprises at least one of:
an area associated with a calculated location of the UE;
a region associated with the calculated location of the UE;
a time period associated with a clock of the UE; or
a duration associated with the clock of the UE.

11. The apparatus of claim 1, wherein the at least one processor, individually or in any combination, is further configured to:
receive a positioning configuration comprising a second indicator of a plurality of positioning model IDs associated with a plurality of positioning models, wherein the plurality of positioning model IDs comprises the selected positioning model ID and a second positioning model ID, wherein selecting the positioning model ID further comprises selecting the plurality of positioning model IDs from the set of positioning model IDs based on the positioning configuration; and
calculate a second set of positioning model outputs based on the measured set of positioning signals and a second positioning model associated with the second positioning model ID.

12. The apparatus of claim 11, wherein the at least one processor, individually or in any combination, is further configured to:
transmit a positioning report comprising a third indicator of the set of positioning model outputs and a fourth indicator of the second set of positioning model outputs.

13. The apparatus of claim 11, wherein the at least one processor, individually or in any combination, is further configured to:
transmit a first positioning report comprising a third indicator of at least one of the set of positioning model outputs; and
transmit a second positioning report comprising a fourth indicator of at least one of the second set of positioning model outputs.

14. The apparatus of claim 11, wherein the at least one processor, individually or in any combination, is further configured to:
obtain a set of measurement inputs;
obtain a set of labels; and
train the plurality of positioning models based on the set of measurement inputs and the set of labels using artificial intelligence machine learning (AI/ML).

15. The apparatus of claim 11, wherein the positioning configuration comprises a third indicator of a first set of resources associated with the positioning model and the measured set of positioning signals and a fourth indicator of a second set of resources associated with the second positioning model and the measured set of positioning signals, wherein, to calculate the set of positioning model outputs and the second set of positioning model outputs, the at least one processor, individually or in any combination, is configured to:
calculate the set of positioning model outputs further based on the first set of resources and the second set of positioning model outputs further based on the second set of resources.

16. The apparatus of claim 11, wherein the positioning configuration comprises a third indicator of a set of resources associated with the positioning model, the second positioning model, and the measured set of positioning signals, wherein, to calculate the set of positioning model outputs and the second set of positioning model outputs, the at least one processor, individually or in any combination, is configured to:
calculate the set of positioning model outputs and the second set of positioning model outputs further based on the set of resources.

17. The apparatus of claim 11, wherein the positioning configuration comprises a third indicator of the positioning model and a fourth indicator of the second positioning model, wherein the at least one processor, individually or in any combination, is further configured to:
transmit a first request for the positioning model based on the third indicator;
transmit a second request for the second positioning model based on the fourth indicator;
receive the positioning model after the transmission of the first request; and
receive the second positioning model after the transmission of the second request.

18. The apparatus of claim 11, wherein the at least one processor, individually or in any combination, is further configured to:
transmit a request for the positioning configuration before the reception of the positioning configuration.

19. The apparatus of claim 18, wherein the at least one processor, individually or in any combination, is further configured to:
receive a third indicator that a network entity has a capability of transmitting the positioning configuration comprising the second indicator for the UE to use the plurality of positioning models, wherein the transmission of the request is in response to the third indicator.

20. The apparatus of claim 11, further comprising at least one of a transceiver or an antenna coupled to the at least one processor, wherein the at least one processor, individually or in any combination, is further configured to:
transmit, via at least one of the transceiver or the antenna, a capability message comprising a third indicator that the UE is configured to concurrently calculate a plurality of positioning model outputs based on the plurality of positioning models before the reception of the positioning configuration.

21. An apparatus for wireless communication at a network entity, comprising:
at least one memory; and
at least one processor coupled to the at least one memory and, based at least in part on information stored in the at least one memory, the at least one processor, individually or in any combination, is configured to:
register a set of positioning model IDs and a set of positioning model configurations with a positioning model ID database such that each of the set of positioning model IDs is associated with at least one of the set of positioning model configurations in the positioning model ID database; and
transmit a positioning model registration message comprising the registered set of positioning model IDs and an indicator of the registered set of positioning model configurations.

22. The apparatus of claim 21, wherein the at least one processor, individually or in any combination, is further configured to:
receive a request message comprising a request for the positioning model registration message, wherein the transmission of the positioning model registration message is in response to the request, wherein the request message further comprises a set of potential IDs.

23. The apparatus of claim 21, wherein the at least one processor, individually or in any combination, is further configured to:
receive a positioning model registration failure message comprising a second indicator of at least one of the set of positioning model IDs that is invalid for registration with a user equipment (UE);
register a second set of positioning model IDs and the set of positioning model configurations with the positioning model ID database such that each of the second set of positioning model IDs is associated with at least one of the set of positioning model configurations in the positioning model ID database, wherein the second set of positioning model IDs does not include at least one of the set of positioning model IDs that is invalid for registration with the UE; and
transmit a second positioning model registration message comprising the second set of positioning model IDs and a third indicator of the set of positioning model configurations.

24. The apparatus of claim 23, wherein the at least one processor, individually or in any combination, is further configured to:
receive a request message comprising a request for the second positioning model registration message, wherein the transmission of the second positioning model registration message is in response to the request.

25. The apparatus of claim 21, wherein the at least one processor, individually or in any combination, is further configured to:
receive a report message comprising a second indicator of a selected positioning model ID and a third indicator of a calculated set of positioning model outputs, wherein the set of positioning model IDs comprises the selected positioning model ID.

26. The apparatus of claim 25, wherein the at least one processor, individually or in any combination, is further configured to:
transmit a positioning model registration failure message comprising a fourth indicator that the selected positioning model ID is invalid for registration; and
transmit a second positioning model registration message comprising a second set of positioning model IDs and a second fifth of the set of positioning model configurations, wherein each of the second set of positioning model IDs is associated with at least one of the set of positioning model configurations, wherein the second set of positioning model IDs does not include the selected positioning model ID.

27. The apparatus of claim 26, further comprising at least one of a transceiver or an antenna coupled to the at least one processor, wherein the at least one processor, individually or in any combination, is further configured to:
receive, via at least one of the transceiver or the antenna, a request message comprising a request for the second positioning model registration message, wherein the transmission of the second positioning model registration message is in response to the request.

28. The apparatus of claim 21, wherein the at least one processor, individually or in any combination, is further configured to:
transmit a positioning configuration comprising a second indicator of a plurality of positioning model IDs, wherein the set of positioning model IDs comprise the plurality of positioning model IDs; and
receive a positioning report comprising a third indicator of a set of positioning model outputs based on the positioning configuration.

29. A method of wireless communication at a user equipment (UE), comprising:
receiving a positioning model registration message comprising a set of positioning model IDs and an indicator of a set of positioning model configurations, wherein each of the set of positioning model IDs is associated with at least one of the set of positioning model configurations;
receiving a set of positioning signals;
measuring the set of positioning signals;
selecting a positioning model ID from the set of positioning model IDs based on the set of positioning model configurations and an environmental attribute of the UE; and
calculating a set of positioning model outputs based on the measured set of positioning signals and a positioning model associated with the selected positioning model ID.

30. A method of wireless communication at a network entity, comprising:
registering a set of positioning model IDs and a set of positioning model configurations with a positioning model ID database such that each of the set of positioning model IDs is associated with at least one of the set of positioning model configurations in the positioning model ID database; and
transmitting a positioning model registration message comprising the registered set of positioning model IDs and an indicator of the registered set of positioning model configurations.
